(19) United States
(12) Patent Application Publication
(10) Pub. No.: US 2026/0313698 A1
(43) Pub. Date: Oct. 8, 2026

(54) METHOD AND DEVICE FOR TRANSMISSION/RECEPTION OF PHYSICAL RANDOM ACCESS CHANNEL IN WIRELESS COMMUNICATION SYSTEM

(71) Applicant: LG ELECTRONICS INC., Seoul (KR)

(72) Inventors: Seokmin SHIN, Seoul (KR); Hyunsoo KO, Seoul (KR)

(73) Assignee: LG ELECTRONICS INC., Seoul (KR)

(21) Appl. No.: 19/472,573

(22) PCT Filed: Apr. 3, 2024
(86) PCT No.: PCT/KR2024/004290

§ 371 Date: Oct. 3, 2025

(30) Foreign Application Priority Data
Apr. 6, 2023 (KR) 10-2023-0045699

(51) Int. Cl. H04W 74/0833; H04W 72/0453

(52) U.S. Cl. CPC H04W 74/0833; H04W 72/0453

(57) ABSTRACT

A method according to an embodiment of the present disclosure includes transmitting a Physical Random Access CHannel (PRACH), and receiving a Random Access Response (RAR). The PRACH is transmitted based on at least one PRACH occasion. The at least one PRACH is determined based on a plurality of PRACH occasions. The at least one PRACH is based on a valid PRACH occasion. Among the plurality of PRACH occasions, a second PRACH occasion related to a second configuration that overlaps with a first PRACH occasion related to a first configuration is determined to be invalid.

### TECHNICAL FIELD

The present disclosure relates to a method and device for transmitting and receiving a physical random access channel in a wireless communication system.

### BACKGROUND

Mobile communication systems have been developed to guarantee user activity while providing voice services. Mobile communication systems are expanding their services from voice only to data. Current soaring data traffic is depleting resources and users' demand for higher-data rate services is leading to the need for more advanced mobile communication systems.

Next-generation mobile communication systems are required to meet, e.g., handling of explosively increasing data traffic, significant increase in per-user transmission rate, working with a great number of connecting devices, and support for very low end-to-end latency and high-energy efficiency. To that end, various research efforts are underway for various technologies, such as dual connectivity, massive multiple input multiple output (MIMO), in-band full duplex, non-orthogonal multiple access (NOMA), super wideband support, and device networking.

PRACH repetition transmission has been introduced to enhance Rel-18 coverage. In this instance, ROs based on different configurations may be configured/allocated.

### DISCLOSURE

### Technical Problem

Two ROs for PRACH repetition transmission may be allocated to overlap entirely or partially. In this case, the following problems may arise. It is unclear whether all or only some of the overlapping ROs are used. Further, if only some ROs are used, the RO used by a UE may different from the RO that a base station expects the UE to use.

The present disclosure provides a method for solving the above-described problems.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

### TECHNICAL SOLUTION

A method performed by a user equipment (UE) according to an embodiment of the present disclosure comprises transmitting a Physical Random Access CHannel (PRACH), and receiving a Random Access Response (RAR).

The PRACH is transmitted based on at least one PRACH occasion. The at least one PRACH is determined based on a plurality of PRACH occasions. The at least one PRACH is based on a valid PRACH occasion.

Among the plurality of PRACH occasions, a second PRACH occasion related to a second configuration that overlaps with a first PRACH occasion related to a first configuration is determined to be invalid.

The plurality of PRACH occasions may include PRACH occasions based on multiple configurations.

The multiple configurations may be based on i) multiple RACH configurations or ii) multiple preamble configurations.

The second configuration may be a configuration determined based on at least one of i) a repetition number, ii) a priority, and/or iii) a serving cell among configurations related to overlapping PRACH occasions.

Based on the configurations being related to a same repetition number, the second configuration may be determined based on the priority.

Based on the configurations being related to a same priority, the second configuration may be determined based on the repetition number.

The repetition number related to the second configuration may be greater than a repetition number related to the first configuration.

The priority related to the second configuration may be lower than a priority related to the first configuration.

The second configuration may be related to a primary secondary cell (PSCell), and the first configuration is related to a primary cell (PCell).

The at least one PRACH occasion may include a frequency division multiplexed (FDMed) PRACH occasion in the same time resource as the second PRACH occasion.

The first PRACH occasion and the second PRACH occasion may be determined as invalid PRACH occasions.

A user equipment (UE) according to another embodiment of the present disclosure comprises one or more transceivers, one or more processors, and one or more memories connected to the one or more processors and configured to store instructions.

The instructions, based on being executed by the one or more processors, configure the one or more processors to perform all steps of any one of the methods.

A device according to another embodiment of the present disclosure comprises one or more memories and one or more processors operably connected to the one or more memories.

The one or more memories are configured to store instructions based on being executed by the one or more processors, and the instructions are configured to allow the one or more processors to perform all steps of any one of the methods.

One or more non-transitory computer readable mediums according to another embodiment of the present disclosure stores instructions.

The instructions executable by one or more processors are configured to allow the one or more processors to perform all steps of any one of the methods.

A method performed by a base station according to another embodiment of the present disclosure comprises receiving a Physical Random Access CHannel (PRACH), and transmitting a Random Access Response (RAR).

The PRACH is received based on at least one PRACH occasion. The at least one PRACH is determined based on a plurality of PRACH occasions. The at least one PRACH is based on a valid PRACH occasion.

Among the plurality of PRACH occasions, a second PRACH occasion related to a second configuration that overlaps with a first PRACH occasion related to a first configuration is determined to be invalid.

A base station according to another embodiment of the present disclosure comprises one or more transceivers, one or more processors, and one or more memories connected to the one or more processors and storing instructions.

The instructions configure the one or more processors to perform all steps of the methods based on being executed by the one or more processors.

### Advantageous Effects

According to embodiments of the present disclosure, ambiguity about which ROs among overlapping ROs are used can be resolved. Furthermore, they can prevent degradation of PRACH transmission and reception performance when some or all of ROs independently/individually allocated based on various configurations (e.g., repetition number, feature combination) overlap.

An effect which can be obtained in the present disclosure are not limited to the aforementioned effect and other unmentioned advantages will be clearly understood by those skilled in the art from the following description.

### DESCRIPTION OF THE DRAWINGS

FIG. 1 illustrates physical channels and general signal transmission used in a 3GPP system.

FIG. 2 illustrates RACH occasions for each preamble format.

FIG. 3 illustrates a random access procedure.

FIG. 4 illustrates an RACH partitioning related RRC parameter.

FIG. 5 is a flowchart for describing a method performed by a user equipment (UE) according to an embodiment of the present disclosure.

FIG. 6 is a flowchart for describing a method performed by a base station (BS) according to another embodiment of the present disclosure.

FIG. 7 illustrates configurations of a first device and a second device according to an embodiment of the present disclosure.

### DETAILED DESCRIPTION

Hereinafter, preferred embodiments of the disclosure are described in detail with reference to the accompanying drawings. The following detailed description taken in conjunction with the accompanying drawings is intended for describing example embodiments of the disclosure, but not for representing a sole embodiment of the disclosure. The detailed description below includes specific details to convey a thorough understanding of the disclosure. However, it will be easily appreciated by one of ordinary skill in the art that embodiments of the disclosure may be practiced even without such details.

In some cases, to avoid ambiguity in concept, known structures or devices may be omitted or be shown in block diagrams while focusing on core features of each structure and device.

Hereinafter, downlink (DL) means communication from a base station to a terminal and uplink (UL) means communication from the terminal to the base station. In the downlink, a transmitter may be part of the base station, and a receiver may be part of the terminal. In the uplink, the transmitter may be part of the terminal and the receiver may be part of the base station. The base station may be expressed as a first communication device and the terminal may be expressed as a second communication device. A base station (BS) may be replaced with terms including a fixed station, a Node B, an evolved-NodeB (eNB), a Next Generation NodeB (gNB), a base transceiver system (BTS), an access point (AP), a network (5G network), an AI system, a road side unit (RSU), a vehicle, a robot, an Unmanned Aerial Vehicle (UAV), an Augmented Reality (AR) device, a Virtual Reality (VR) device, and the like. Further, the terminal may be fixed or mobile and may be replaced with terms including a User Equipment (UE), a Mobile Station (MS), a user terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, and a Device-to-Device (D2D) device, the vehicle, the robot, an AI module, the Unmanned Aerial Vehicle (UAV), the Augmented Reality (AR) device, the Virtual Reality (VR) device, and the like.

### Physical Channel and General Signal Transmission

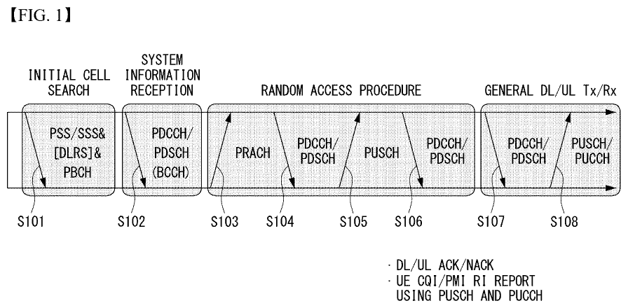

FIG. 1 illustrates physical channels and general signal transmission used in a 3GPP system. In a wireless communication system, the UE receives information from the eNB through Downlink (DL) and the UE transmits information from the eNB through Uplink (UL). The information which the eNB and the UE transmit and receive includes data and various control information and there are various physical channels according to a type/use of the information which the eNB and the UE transmit and receive.

When the UE is powered on or newly enters a cell, the UE performs an initial cell search operation such as synchronizing with the eNB (S101). To this end, the UE may receive a Primary Synchronization Signal (PSS) and a (Secondary Synchronization Signal (SSS) from the eNB and synchronize with the eNB and acquire information such as a cell ID or the like. Thereafter, the UE may receive a Physical Broadcast Channel (PBCH) from the eNB and acquire in-cell broadcast information. The UE receives a Downlink Reference Signal (DL RS) in an initial cell search step to check a downlink channel status.

A UE that completes the initial cell search receives a Physical Downlink Control Channel (PDCCH) and a Physical Downlink Control Channel (PDSCH) according to information loaded on the PDCCH to acquire more specific system information (S102).

When there is no radio resource first accessing the eNB or for signal transmission, the UE may perform a Random Access Procedure (RACH) to the eNB (S103 to S106). To this end, the UE may transmit a specific sequence to a preamble through a Physical Random Access Channel (PRACH) (S103 and S105) and receive a response message (Random Access Response (RAR) message) for the preamble through the PDCCH and a corresponding PDSCH. In the case of a contention based RACH, a Contention Resolution Procedure may be additionally performed (S106).

The UE that performs the above procedure may then perform PDCCH/PDSCH reception (S107) and Physical Uplink Shared Channel (PUSCH)/Physical Uplink Control Channel (PUCCH) transmission (S108) as a general uplink/downlink signal transmission procedure. In particular, the UE may receive Downlink Control Information (DCI) through the PDCCH. Here, the DCI may include control information such as resource allocation information for the UE and formats may be differently applied according to a use purpose.

The control information which the UE transmits to the eNB through the uplink or the UE receives from the eNB may include a downlink/uplink ACK/NACK signal, a Channel Quality Indicator (CQI), a Precoding Matrix Index (PMI), a Rank Indicator (RI), and the like. The UE may transmit the control information such as the CQI/PMI/RI, etc., through the PUSCH and/or PUCCH.

An RACH slot is described below.

An RACH slot includes one or multiple RACH Occasion(s).

Slot duration is 1 ms for {1.25 kHz, 5 kHz} subcarrier spacing, and has scalable duration (i.e., 1 ms, 0.5 ms, 0.25 ms, 0.125 ms) for {15 kHz, 30 kHz, 60 kHz, 120 kHz} subcarrier spacing.

A start OFDM symbol index in an RACH slot has {0,2,x} values for short preamble formats.

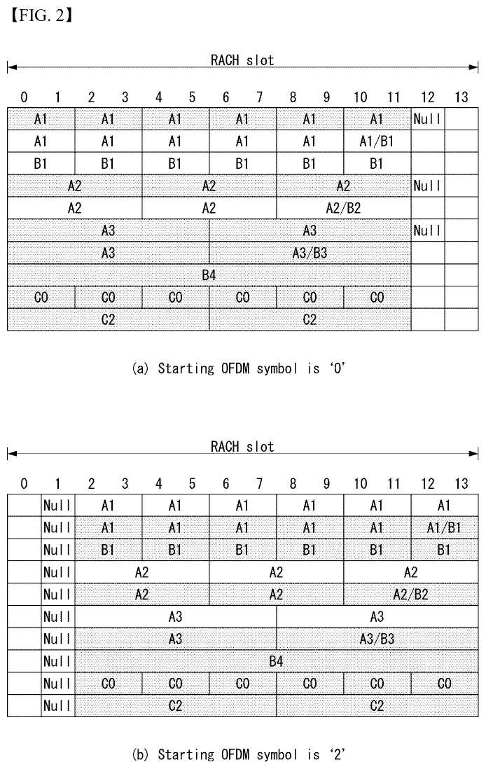

FIG. 2 illustrates RACH occasions for each preamble format.

Referring to FIG. 2, an RACH slot may include one or more RACH occasions (ROs) for each preamble format (e.g., A1, A2, . . . , C2). (a) of FIG. 2 illustrates a case in which a starting OFDM symbol is ‘0’, and (b) of FIG. 2 illustrates a case in which a starting OFDM symbol is ‘2’.

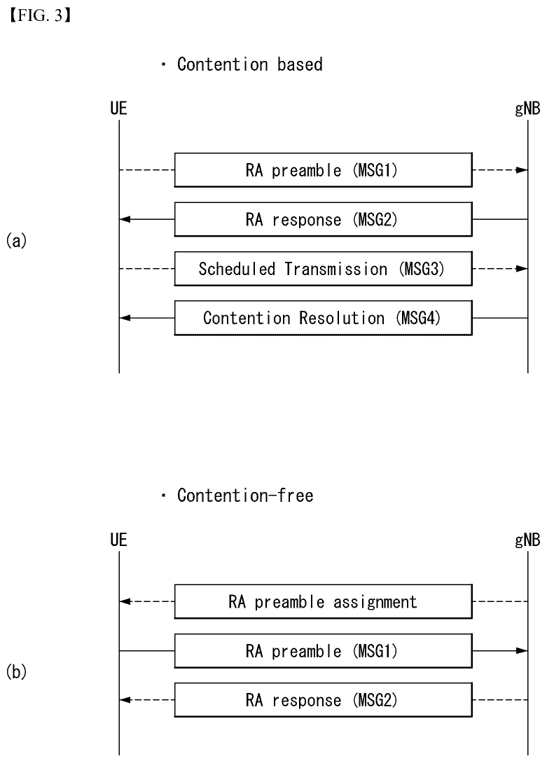

FIG. 3 illustrates a random access procedure.

(a) of FIG. 3 illustrates a contention based RACH procedure, and (b) of FIG. 3 illustrates a contention free RACH procedure.

MSG1 transmission is described below.

Subcarrier spacing for MSG1 is configured in an RACH configuration, and is provided in a handover command with respect to a contention-free RA procedure for handover.

Preamble indices for contention-based random access (CBRA) and contention-free random access (CFRA) are consecutively mapped to one SSB in one RACH transmission occasion.
CBRA: Association between an SS block (SSB) within an SS burst set and a subset of RACH resources and/or preamble indices is configured by a parameter set in an RMSI.
CFRA: A UE may be configured transmit multi-MSG1s through a dedicated multi-RACH transmission occasion in the time domain before the end of a monitored RAR window.

Furthermore, association between a CFRA preamble and an SSB is reconfigured through UE-specific RRC.

The random access procedure may be a Type-1 random access procedure (4-step RA) or a Type-2 random access procedure (2-step RA).

The Type-1 random access procedure may include transmission of random access preamble in a physical random access channel (PRACH) (Msg1), reception of a random access response (RAR) (Msg2), transmission of PUSCH scheduled by UL grant of the RAR (Msg3), and PDSCH for contention resolution (Msg4). If the random access procedure is contention free random access (CFRA), the Msg3 transmission and the Msg4 reception are omitted.

The Type-2 random access procedure may include transmission of random access preamble and PUSCH (MsgA) and RAR reception (MsgB).

The following Table 1 shows configurations/operations related to the random access preamble.

```
TABLE 1
8.1 Random access preamble
Physical random access procedure for a UE is triggered upon request of a PRACH transmission
by higher layers or by a PDCCH order for a cell. A configuration by higher layers for a
PRACH transmission includes the following:
  A configuration for PRACH transmission on the cell [4, TS 38.211].
  A preamble index, a preamble SCS, P_{PRACH,target}, a corresponding RA-RNTI when applicable
  [11, TS 38.321], and a PRACH resource for the cell.
  $A number of {N}_{preamble}^{rep} > 1 preamble repetitions for the PRACH$
  transmission if the UE would transmit the PRACH with repetitions.
A UE transmits a PRACH on a cell using the selected PRACH format with transmission
power P_{PRACH,b,f,c}(i), as described in clause 7.4, on the indicated
$PRACH resource or on a determined set of {N}_{preamble}^{rep} resources using a same$
$spatial filter in case of {N}_{preamble}^{rep} preamble repetitions .$
For Type-1 random access procedure, a UE is provided a number N of SS/PBCH block indexes
associated with one PRACH occasion and a number R of contention based preambles per
SS/PBCH block index per valid PRACH occasion
by ssb-perRACH-OccasionAndCB-PreamblesPerSSB.
For Type-2 random access procedure with common configuration of PRACH
occasions with Type-1 random access procedure, a UE is provided a number N
of SS/PBCH block indexes associated with one PRACH occasion by ssb-
perRACH-OccasionAndCB-PreamblesPerSSB and a number Q of contention
based preambles per SS/PBCH block index per valid PRACH occasion by msgA-
CB-PreamblesPerSSB-PerSharedRO. The PRACH transmission can be on a
subset of PRACH occasions associated with a same SS/PBCH block index within
an SSB-RO mapping cycle for a UE provided with a PRACH mask index by
msgA-SSB-SharedRO-MaskIndex according to [11, TS 38.321].
For Type-2 random access procedure with separate configuration of PRACH
occasions with Type-1 random access procedure, a UE is provided a number N
of SS/PBCH block indexes associated with one PRACH occasion and a number
R of contention based preambles per SS/PBCH block index per valid PRACH
occasion by msgA-SSB-PerRACH-OccasionAndCB-PreamblesPerSSB when
provided; otherwise, by ssb-perRACH-OccasionAndCB-PreamblesPerSSB.
For a random access procedure associated with a feature combination indicated by
FeatureCombinationPreambles, a UE is provided a number N of SS/PBCH
block indexes associated with one PRACH occasion by ssb-perRACH-
OccasionAndCB-PreamblesPerSSB or msgA-SSB-PerRACH-OccasionAndCB-
PreamblesPerSSB when provided and a number S of contention based preambles
per SS/PBCH block index per valid PRACH occasion by
startPreambleFor ThisPartition and numberOfPreamblesPerSSB-
ForThisPartition. The PRACH transmission can be on a subset of PRACH
occasions associated with a same SS/PBCH block index within an SSB-RO
mapping cycle for a UE provided with a PRACH mask index by ssb-SharedRO-
MaskIndex according to [11, TS 38.321].
For Type-1 random access procedure, or for Type-2 random access procedure
with separate configuration of PRACH occasions from Type 1 random access
procedure, if N < 1, one SS/PBCH block index is mapped to 1/N consecutive
valid PRACH occasions and R contention
based preambles with consecutive indexes associated with the SS/PBCH block
index per valid PRACH occasion start from preamble index 0. If N ≥ 1, R
contention based preambles with consecutive indexes associated with SS/PBCH
block index n, 0 ≤ n ≤ N − 1, per valid PRACH occasion start from preamble
$index n \cdot {N}_{preamble}^{total} / N where {N}_{preamble}^{total} is provided by totalNumberOfRA - Preambles$
for Type-1 random access procedure, or by msgA-TotalNumberOfRA-
Preambles for Type-2 random access procedure with separate configuration of
PRACH occasions from a Type 1 random access procedure, and is an integer multiple of N.
For Type-2 random access procedure with common configuration of PRACH
occasions with Type-1 random access procedure, if N < 1, one SS/PBCH block
index is mapped to 1/N consecutive valid PRACH occasions and Q contention
based preambles with consecutive indexes associated with the SS/PBCH block
index per valid PRACH occasion start from preamble index R. If N ≥ 1, Q
contention based preambles with consecutive indexes associated with SS/PBCH
block index n, 0 ≤ n ≤ N − 1, per valid PRACH occasion start from preamble
$index n \cdot {N}_{preamble}^{total} / N + R , where {N}_{preamble}^{total} is provided by totalNumberOfRA - Preambles$
for Type-1 random access procedure.
For link recovery, a UE is provided N SS/PBCH block indexes associated with
one PRACH occasion by ssb-perRACH-Occasion in BeamFailureRecoveryConfig.
For a dedicated RACH configuration provided by RACH-ConfigDedicated, if cfra is provided,
a UE is provided N SS/PBCH block indexes associated with one PRACH occasion by
ssb-perRACH-Occasion in occasions. If N < 1, one SS/PBCH block index is mapped to
1/N consecutive valid PRACH occasions. If N ≥ 1, all consecutive N SS/PBCH block indexes
are associated with one PRACH occasion.
SS/PBCH block indexes provided by ssb-PositionsInBurst in SIB1 or in
ServingCellConfigCommon are mapped to valid PRACH occasions in the
following order where the parameters are described in [4, TS 38.211].
  First, in increasing order of preamble indexes within a single PRACH occasion
  Second, in increasing order of frequency resource indexes for frequency multiplexed
  PRACH occasions
  Third, in increasing order of time resource indexes for time multiplexed PRACH occasions
  within a PRACH slot
  Fourth, in increasing order of indexes for PRACH slots
An association period, starting from frame 0, for mapping SS/PBCH block indexes
to PRACH occasions is the smallest integer number in the set determined by the
$PRACH configuration period according Table 8.1 - 1 such that {N}_{Tx}^{SSB} SS / PBCH$
block indexes are mapped at least once to the PRACH occasions within the
$association period , where a UE obtains {N}_{Tx}^{SSB} from the value of ssb - PositionsInBurst$
in SIB1 or in ServingCellConfigCommon. If after an integer
number of SS/PBCH block indexes to PRACH occasions mapping cycles within
the association period there is a set of PRACH occasions or PRACH preambles that
$are not mapped to {N}_{Tx}^{SSB} SS / PBCH block indexes , no SS / PBCH block indexes are$
mapped to the set of PRACH occasions or PRACH preambles. An association
pattern period includes one or more association periods and is determined so that a
pattern between PRACH occasions and SS/PBCH block indexes repeats at most every
160 msec.
PRACH occasions not associated with SS/PBCH block indexes after an integer
number of association periods, if any, are not used for PRACH transmissions.
For a PRACH transmission by a UE triggered by a PDCCH order, the PRACH
mask index field, if the value of the random access preamble index field is not
zero, indicates the PRACH occasion for the PRACH transmission where the
PRACH occasions are associated with the SS/PBCH block index indicated by the
SS/PBCH block index field of the PDCCH order and, if any, a cell indicator field
indicates a cell for the PRACH transmission [5, TS 38.212]. If the UE is provided
K_{cell,offset} by cellSpecificKoffset, the PRACH occasion is after slot n + 2^{μ} · K_{cell,offset}
where n is the slot of the UL BWP for the PRACH transmission
that overlaps with the end of the PDCCH order reception assuming T_{TA} = 0, and
μ is the SCS configuration for the PRACH transmission. If the PDCCH reception
for the PDCCH order includes two PDCCH candidates from two linked search
space sets based on searchSpaceLinkingId, as described in clause 10.1, the last
symbol of the PDCCH reception is the last symbol of the PDCCH candidate that
ends later. The PDCCH reception includes the two PDCCH candidates also when
the UE is not required to monitor one of the two PDCCH candidates as described
in clauses 10 (except clause 10.4), 11.1, 11.1.1 and 17.2.
For a PRACH transmission triggered by higher layers, if ssb-ResourceList is
provided, the PRACH mask index is indicated by ra-ssb-OccasionMaskIndex
which indicates the PRACH occasions for the PRACH transmission where the
PRACH occasions are associated with the selected SS/PBCH block index.
The PRACH occasions are mapped consecutively per corresponding SS/PBCH
block index. The indexing of the PRACH occasion indicated by the mask index
value is reset per mapping cycle of consecutive PRACH occasions per SS/PBCH
block index. The UE selects for a PRACH transmission the PRACH occasion
indicated by PRACH mask index value for the indicated SS/PBCH block index in
the first available mapping cycle.
For the indicated preamble index, the ordering of the PRACH occasions is
  First, in increasing order of frequency resource indexes for frequency
  multiplexed PRACH occasions
  Second, in increasing order of time resource indexes for time multiplexed
  PRACH occasions within a PRACH slot
  Third, in increasing order of indexes for PRACH slots
$For a PRACH transmission with {N}_{preamble}^{rep} preamble repetitions , a set consists of$
${N}_{preamble}^{rep} valid PRACH occasions that are consecutive in time , use name$
frequency resources, and are associated with same one or more SS/PBCH block
index(es), and each SS/PBCH block index is associated with same preamble
indexes in all valid PRACH occasions within the set.
For a PRACH transmission with preamble repetitions, a time period, starting from
frame 0, is the smallest integer number of association pattern periods such that at
$least one set of valid PRACH occasions for each of the {N}_{Tx}^{SSB} SS / PBCH block$
indexes can be determined within the time period for all configured number of
preamble repetitions. The set(s) of valid PRACH occasions for each configured
number of preamble repetitions repeats every time period.
$Within a time period , for set ( s ) of {N}_{preamble}^{rep} valid PRACH occasions for a$
$PRACH transmission with {N}_{preamble}^{rep} preamble repetitions$
  the first valid PRACH occasion of the first set is the first valid PRACH occasion
  the first valid PRACH occasion of subsequent sets, if any, is determined
  according to an ordering of valid PRACH occasions
    first, in increasing order of frequency resource indexes for frequency
    multiplexed PRACH occasions
    second, in increasing order of time resource indexes for time multiplexed
    PRACH occasions
where, for each frequency resource index for frequency multiplexed PRACH occasions
  the first valid PRACH occasion of the first set is the first valid PRACH occasion
  the first valid PRACH occasion of subsequent sets, if any,
    is after TimeOffsetBetweenStartingRO consecutive valid PRACH
    occasions in time from the first valid PRACH occasion of the previous
    set, where each PRACH occasion is associated with same SS/PBCH
    block index(es) and each SS/PBCH block index is associated with same
    preambles, if TimeOffsetBetweenStartingRO is provided
    is after the PRACH occasions for the previous set, if TimeOffsetBetweenStartingRO
    is not provided
For a PRACH transmission triggered upon request by higher layers, a value of ra-OccasionList
[12, TS 38.331], if csirs-ResourceList is provided, indicates a list of PRACH occasions for the
PRACH transmission where the PRACH occasions are associated with the selected CSI-RS
index indicated by csi-RS. The indexing of the PRACH occasions indicated by ra-OccasionList
is reset per association pattern period.
```

TABLE 8.1-1
Mapping between PRACH configuration period and SS/PBCH
block to PRACH occasion association period

| PRACH configuration period | Association period (number of |
|---|---|
| (msec) | PRACH configuration periods) |
| 10 | {1, 2, 4, 8, 16} |
| 20 | {1, 2, 4, 8} |
| 40 | {1, 2, 4} |
| 80 | {1, 2} |
| 160 | {1} |

```
For paired spectrum or supplementary uplink band all PRACH occasions are valid.
For unpaired spectrum,
      - if a UE is not provided tdd-UL-DL-ConfigurationCommon, a PRACH
        occasion in a PRACH slot is valid if it does not precede a SS/PBCH block
        in the PRACH slot and starts at least N_{gap} symbols after a last SS/PBCH
        block reception symbol, where N_{gap} is provided in Table 8.1-2 and, if
        channelAccessMode = “semiStatic” is provided, does not overlap with a
        set of consecutive symbols before the start of a next channel occupancy
        time where the UE does not transmit [15, TS 37.213].
        - the candidate SS/PBCH block index of the SS/PBCH block corresponds
            to the SS/PBCH block index provided by ssb-PositionsInBurst in SIBI or
            in ServingCellConfigCommon, as described in clause 4.1
      - If a UE is provided tdd-UL-DL-ConfigurationCommon, a PRACH occasion
        in a PRACH slot is valid if
            - it is within UL symbols, or
            - it does not precede a SS/PBCH block in the PRACH slot and starts at
              least N_{gap} symbols after a last downlink symbol and at least N_{gap}
              symbols after a last SS/PBCH block symbol, where N_{gap} is provided in
              Table 8.1-2, and if channelAccessMode = “semiStatic” is provided, does
              not overlap with a set of consecutive symbols before the start of a next
              channel occupancy time where there shall not be any transmissions, as
              described in [15, TS 37.213]
              - the candidate SS/PBCH block index of the SS/PBCH block
                corresponds to the SS/PBCH block index provided by ssb-
                PositionsInBurst in SIBI or in ServingCellConfigCommon, as
                described in clause 4.1.
For preamble format B4 [4, TS 38.211], N_{gap} = 0.
Table 8.1-2: N_{gap} values for different preamble SCS μ
```

| Preamble SCS | N_{gap} |
|---|---|
| 1.25 kHz or 5 kHz | 0 |
| 15 kHz or 30 kHz or 60 kHz or 120 kHz | 2 |
| 480 kHz | 8 |
| 960 kHz | 16 |

```
If a random access procedure is initiated by a PDCCH order, the UE, if requested
by higher layers, transmits a PRACH in the selected PRACH occasion, as
described in [11, TS 38.321], for which a time between the last symbol of the
PDCCH order reception and the first symbol of the PRACH transmission is larger
than or equal to N_{T,2} + T_{BWPswitchDelay} + Δ_{Delay} + T_{switch} + T_{SSB} +
Δ_{RF/BB preparation} msec, where
      - N_{T,2} is a time duration of N₂ symbols corresponding to a PUSCH
        preparation time for UE processing capability 1 [6, TS 38.214] assuming μ
        corresponds to the smallest SCS configuration between the SCS
        configuration of the PDCCH order and the SCS configuration of the
        corresponding PRACH transmission
      - T_{BWPswitchDelay} = 0 if the active UL BWP does not change, or if a cell
        indicator field in the PDCCH order indicates a non-serving cell [5, TS
        38.212], and T_{BWPswitch Delay} is defined in [10, TS 38.133] otherwise
      - Δ_{Delay} = 0.5 msec for FRI and Δ_{Delay} = 0.25 msec for FR2
      - T_{switch} is a switching gap duration as defined in [6, TS 38.214]
      - T_{SSB} = 0 if a cell indicator field in the PDCCH order indicates a serving
        cell or if cell indicator field is not present, and T_{SSB} is defined in [10, TS
        38.133] otherwise
      - Δ_{RF/BB preparation} = 0 if a cell indicator field in the PDCCH order indicates
        a serving cell or if cell indicator field is not present, and Δ_{RF/BB preparation}
        is defined in [10, TS 38.133] otherwise
For a PRACH transmission using 1.25 kHz or 5 kHz SCS, the UE determines N₂
assuming SCS configuration μ = 0.
For single cell operation or for operation with contiguous carrier aggregation in a
same frequency band or for operation with non-contiguous carrier aggregation in
a same frequency band if the UE is not provided with intraBandNC-PRACH-
simulTx-r 17, a UE
      - does not transmit PRACH and PUSCH/PUCCH/SRS in a same slot with
        respect to the smallest SCS configuration between the SCS configuration for
        the UL BWP with the PRACH and the SCS configuration for the UL BWP
        with the PUSCH/PUCCH/SRS transmissions,
      - does not transmit PRACH and PUSCH/PUCCH/SRS when a first or last
        symbol of a PRACH transmission in a first slot is separated by less than N
        symbols from the last or first symbol, respectively, of a
        PUSCH/PUCCH/SRS transmission in a second slot
      $- for PRACH transmission with {N}_{preamble}^{rep} > 1 preamble repetitions , if the$
        UE does not indicate capability-XYZ, the UE does not transmit a first
        repetition of the PRACH and a second repetition of the PRACH when a first
        or last symbol of the first repetition of the PRACH in a first slot is separated
        by less than N symbols from the last or first symbol, respectively, of the
        second repetition of the PRACH in a second slot; otherwise, the UE
        transmits the first repetition of the PRACH and the second repetition of the PRACH
where N = 2 for μ = 0 or u =1, N = 4 for μ = 2 or μ = 3, N = 16 for
μ = 5, N = 32 for μ = 6, and μ is the smallest SCS configuration between the
SCS configuration for the UL BWP with the PRACH and the SCS configuration
for the UL BWP with the PUSCH/PUCCH/SRS transmissions. For a PUSCH
transmission with repetition Type B, this applies to each actual repetition for
PUSCH transmission [6, TS 38.214].
```

The configurations/definitions/operations according to Table 1 above may be referred to in order to clarify definitions/operations of embodiments to be described below. As an example, in an embodiment to be described below, ROs may refer to the valid PRACH occasions mentioned in Table 1. As an example, in an embodiment to be described below, multiple ROs having a same beam index may mean 1/N (where, N<1) consecutive valid PRACH occasions to which one SS/PBCH index is mapped.

Tables 2 to 4 below illustrate PRACH configuration tables to which the embodiments to be described below may be applied.

TABLE 2
Table 6.3.3.2-2: Random access configurations for
FRI and paired spectrum/supplementary uplink.

| | | | | | | | N^{RA,slot}, | |
|---|---|---|---|---|---|---|---|---|
| | | | | | | | number | |
| | | | | | | | of | |
| | | | | | | | time- | |
| | | | | | | | domain | |
| | | | | | | Number | PRACH | |
| | | | | | | of | ccasions | |
| | | | | | | PRACH | within | |
| PRACH | | | | | | slots | a | N_{dur}^{RA}, |
| Configuration | Preamble | n_{SFN}^{modx} = y | | Subframe | Starting | within a | PRACH | PRACH |
| index | format | x | y | number | symbol | subframe | slot | duration |
| 0 | 0 | 0 | 16 | 1 | 1 | — | — | 0 |
| 1 | 1 | 0 | 16 | 1 | 4 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| 7 | 0 | 8 | 1 | 9 | 0 | — | — | 0 |
| 8 | 0 | 4 | 1 | 1 | 0 | — | — | 0 |
| 9 | 0 | 4 | 1 | 4 | 0 | — | — | 0 |
| 10 | 0 | 4 | 1 | 7 | 0 | — | — | 0 |
| 11 | 0 | 4 | 1 | 9 | 0 | — | — | 0 |
| 12 | 0 | 2 | 1 | 1 | 0 | — | — | 0 |
| 13 | 0 | 2 | 1 | 4 | 0 | — | — | 0 |
| 14 | 0 | 2 | 1 | 7 | 0 | — | — | 0 |
| 15 | 0 | 2 | 1 | 9 | 0 | — | — | 0 |
| 16 | 0 | 1 | 0 | 1 | 0 | — | — | 0 |
| 17 | 0 | 1 | 0 | 4 | 0 | — | — | 0 |
| 18 | 0 | 1 | 0 | 7 | 0 | — | — | 0 |
| 19 | 0 | 1 | 0 | 1, 6 | 0 | — | — | 0 |
| 20 | 0 | 1 | 0 | 2, 7 | 0 | — | — | 0 |
| 21 | 0 | 1 | 0 | 3, 8 | 0 | — | — | 0 |
| 22 | 0 | 1 | 0 | 1, 4, 7 | 0 | — | — | 0 |
| 23 | 0 | 1 | 0 | 2, 5, 8 | 0 | — | — | 0 |
| 24 | 0 | 1 | 0 | 3, 6, 9 | 0 | — | — | 0 |
| 25 | 0 | 1 | 0 | 0, 2, 4, 6, 8 | 0 | — | — | 0 |
| 26 | 0 | 1 | 0 | 1, 3, 5, 7, 9 | 0 | — | — | 0 |
| 27 | 0 | 1 | 0 | 0, 1, 2, 3, 4, | 0 | — | — | 0 |
| | | | | 5, 6, 7, 8, 9 | | | | |
| 28 | 1 | 16 | 1 | 1 | 0 | — | — | 0 |
| 29 | 1 | 16 | 1 | 4 | 0 | — | — | 0 |
| 30 | 1 | 16 | 1 | 7 | 0 | — | — | 0 |
| 31 | 1 | 16 | 1 | 9 | 0 | — | — | 0 |
| 32 | 1 | 8 | 1 | 1 | 0 | — | — | 0 |
| 33 | 1 | 8 | 1 | 4 | 0 | — | — | 0 |
| 34 | 1 | 8 | 1 | 7 | 0 | — | — | 0 |
| 35 | 1 | 8 | 1 | 9 | 0 | — | — | 0 |
| 36 | 1 | 4 | 1 | 1 | 0 | — | — | 0 |
| 37 | 1 | 4 | 1 | 4 | 0 | — | — | 0 |
| 38 | 1 | 4 | 1 | 7 | 0 | — | — | 0 |
| 39 | 1 | 4 | 1 | 9 | 0 | — | — | 0 |
| 40 | 1 | 2 | 1 | 1 | 0 | — | — | 0 |
| 41 | 1 | 2 | 1 | 4 | 0 | — | — | 0 |
| 42 | 1 | 2 | 1 | 7 | 0 | — | — | 0 |
| 43 | 1 | 2 | 1 | 9 | 0 | — | — | 0 |
| 44 | 1 | 1 | 0 | 1 | 0 | — | — | 0 |
| 45 | 1 | 1 | 0 | 4 | 0 | — | — | 0 |
| 46 | 1 | 1 | 0 | 7 | 0 | — | — | 0 |
| 47 | 1 | 1 | 0 | 1, 6 | 0 | — | — | 0 |
| 48 | 1 | 1 | 0 | 2, 7 | 0 | — | — | 0 |
| 49 | 1 | 1 | 0 | 3, 8 | 0 | — | — | 0 |
| 50 | 1 | 1 | 0 | 1, 4, 7 | 0 | — | — | 0 |
| 51 | 1 | 1 | 0 | 2, 5, 8 | 0 | — | — | 0 |
| 52 | 1 | 1 | 0 | 3, 6, 9 | 0 | — | — | 0 |
| 53 | 2 | 16 | 1 | 1 | 0 | — | — | 0 |
| 54 | 2 | 8 | 1 | 1 | 0 | — | — | 0 |
| 55 | 2 | 4 | 0 | 1 | 0 | — | — | 0 |
| 56 | 2 | 2 | 0 | 1 | 0 | — | — | 0 |
| 57 | 2 | 2 | 0 | 5 | 0 | — | — | 0 |
| 58 | 2 | 1 | 0 | 1 | 0 | — | — | 0 |
| 59 | 2 | 1 | 0 | 5 | 0 | — | — | 0 |
| 60 | 3 | 16 | 1 | 1 | 0 | — | — | 0 |
| 61 | 3 | 16 | 1 | 4 | 0 | — | — | 0 |
| 62 | 3 | 16 | 1 | 7 | 0 | — | — | 0 |
| 63 | 3 | 16 | 1 | 9 | 0 | — | — | 0 |
| 64 | 3 | 8 | 1 | 1 | 0 | — | — | 0 |
| 65 | 3 | 8 | 1 | 4 | 0 | — | — | 0 |
| 66 | 3 | 8 | 1 | 7 | 0 | — | — | 0 |
| 67 | 3 | 4 | 1 | 1 | 0 | — | — | 0 |
| 68 | 3 | 4 | 1 | 4 | 0 | — | — | 0 |
| 69 | 3 | 4 | 1 | 7 | 0 | — | — | 0 |
| 70 | 3 | 4 | 1 | 9 | 0 | — | — | 0 |
| 71 | 3 | 2 | 1 | 1 | 0 | — | — | 0 |
| 72 | 3 | 2 | 1 | 4 | 0 | — | — | 0 |
| 73 | 3 | 2 | 1 | 7 | 0 | — | — | 0 |
| 74 | 3 | 2 | 1 | 9 | 0 | — | — | 0 |
| 75 | 3 | 1 | 0 | 1 | 0 | — | — | 0 |
| 76 | 3 | 1 | 0 | 4 | 0 | — | — | 0 |
| 77 | 3 | 1 | 0 | 7 | 0 | — | — | 0 |
| 78 | 3 | 1 | 0 | 1, 6 | 0 | — | — | 0 |
| 79 | 3 | 1 | 0 | 2, 7 | 0 | — | — | 0 |
| 80 | 3 | 1 | 0 | 3, 8 | 0 | — | — | 0 |
| 81 | 3 | 1 | 0 | 1, 4, 7 | 0 | — | — | 0 |
| 82 | 3 | 1 | 0 | 2, 5, 8 | 0 | — | — | 0 |
| 83 | 3 | 1 | 0 | 3, 6, 9 | 0 | — | — | 0 |
| 84 | 3 | 1 | 0 | 0, 2, 4, 6, 8 | 0 | — | — | 0 |
| 85 | 3 | 1 | 0 | 1, 3, 5, 7, 9 | 0 | — | — | 0 |
| 86 | 3 | 1 | 0 | 0, 1, 2, 3, 4, | 0 | — | — | 0 |
| | | | | 5, 6, 7, 8, 9 | | | | |
| 87 | A1 | 16 | 0 | 4, 9 | 0 | 1 | 6 | 2 |
| 88 | A1 | 16 | 1 | 4 | 0 | 2 | 6 | 2 |
| 89 | A1 | 8 | 0 | 4, 9 | 0 | 1 | 6 | 2 |
| 90 | A1 | 8 | 1 | 4 | 0 | 2 | 6 | 2 |
| 91 | A1 | 4 | 0 | 4, 9 | 0 | 1 | 6 | 2 |
| 92 | A1 | 4 | 1 | 4, 9 | 0 | 1 | 6 | 2 |
| 93 | A1 | 4 | 0 | 4 | 0 | 2 | 6 | 2 |
| 94 | A1 | 2 | 0 | 4, 9 | 0 | 1 | 6 | 2 |
| 95 | A1 | 2 | 0 | 1 | 0 | 2 | 6 | 2 |
| 96 | A1 | 2 | 0 | 4 | 0 | 2 | 6 | 2 |
| 97 | A1 | 2 | 0 | 7 | 0 | 2 | 6 | 2 |
| 98 | A1 | 1 | 0 | 4 | 0 | 1 | 6 | 2 |
| 99 | A1 | 1 | 0 | 1, 6 | 0 | 1 | 6 | 2 |
| 100 | A1 | 1 | 0 | 4, 9 | 0 | 1 | 6 | 2 |
| 101 | A1 | 1 | 0 | 1 | 0 | 2 | 6 | 2 |
| 102 | A1 | 1 | 0 | 7 | 0 | 2 | 6 | 2 |
| 103 | A1 | 1 | 0 | 2, 7 | 0 | 2 | 6 | 2 |
| 104 | A1 | 1 | 0 | 1, 4, 7 | 0 | 2 | 6 | 2 |
| 105 | A1 | 1 | 0 | 0, 2, 4, 6, 8 | 0 | 2 | 6 | 2 |
| 106 | A1 | 1 | 0 | 0, 1, 2, 3, 4, | 0 | 2 | 6 | 2 |
| | | | | 5, 6, 7, 8, 9 | | | | |
| 107 | A1 | 1 | 0 | 1, 3, 5, 7, 9 | 0 | 2 | 6 | 2 |
| 108 | A1/B1 | 2 | 0 | 4, 9 | 0 | 1 | 7 | 2 |
| 109 | A1/B1 | 2 | 0 | 4 | 0 | 2 | 7 | 2 |
| 110 | A1/B1 | 1 | 0 | 4 | 0 | 1 | 7 | 2 |
| 111 | A1/B1 | 1 | 0 | 1, 6 | 0 | 1 | 7 | 2 |
| 112 | A1/B1 | 1 | 0 | 4, 9 | 0 | 1 | 7 | 2 |
| 113 | A1/B1 | 1 | 0 | 1 | 0 | 2 | 7 | 2 |
| 114 | A1/B1 | 1 | 0 | 7 | 0 | 2 | 7 | 2 |
| 115 | A1/B1 | 1 | 0 | 1, 4, 7 | 0 | 2 | 7 | 2 |
| 116 | A1/B1 | 1 | 0 | 0, 2, 4, 6, 8 | 0 | 2 | 7 | 2 |
| 117 | A2 | 16 | 1 | 2, 6, 9 | 0 | 1 | 3 | 4 |
| 118 | A2 | 16 | 1 | 4 | 0 | 2 | 3 | 4 |
| 119 | A2 | 8 | 1 | 2, 6, 9 | 0 | 1 | 3 | 4 |
| 120 | A2 | 8 | 1 | 4 | 0 | 2 | 3 | 4 |
| 121 | A2 | 4 | 0 | 2, 6, 9 | 0 | 1 | 3 | 4 |
| 122 | A2 | 4 | 0 | 4 | 0 | 2 | 3 | 4 |
| 123 | A2 | 2 | 1 | 2, 6, 9 | 0 | 1 | 3 | 4 |
| 124 | A2 | 2 | 0 | 1 | 0 | 2 | 3 | 4 |
| 125 | A2 | 2 | 0 | 4 | 0 | 2 | 3 | 4 |
| 126 | A2 | 2 | 0 | 7 | 0 | 2 | 3 | 4 |
| 127 | A2 | 1 | 0 | 4 | 0 | 1 | 3 | 4 |
| 128 | A2 | 1 | 0 | 1, 6 | 0 | 1 | 3 | 4 |
| 129 | A2 | 1 | 0 | 4, 9 | 0 | 1 | 3 | 4 |
| 130 | A2 | 1 | 0 | 1 | 0 | 2 | 3 | 4 |
| 131 | A2 | 1 | 0 | 7 | 0 | 2 | 3 | 4 |
| 132 | A2 | 1 | 0 | 2, 7 | 0 | 2 | 3 | 4 |
| 133 | A2 | 1 | 0 | 1, 4, 7 | 0 | 2 | 3 | 4 |
| 134 | A2 | 1 | 0 | 0, 2, 4, 6, 8 | 0 | 2 | 3 | 4 |
| 135 | A2 | 1 | 0 | 0, 1, 2, 3, 4, | 0 | 2 | 3 | 4 |
| | | | | 5, 6, 7, 8, 9 | | | | |
| 136 | A2 | 1 | 0 | 1, 3, 5, 7, 9 | 0 | 2 | 3 | 4 |
| 137 | A2/B2 | 2 | 1 | 2, 6, 9 | 0 | 1 | 3 | 4 |
| 138 | A2/B2 | 2 | 0 | 4 | 0 | 2 | 3 | 4 |
| 139 | A2/B2 | 1 | 0 | 4 | 0 | 1 | 3 | 4 |
| 140 | A2/B2 | 1 | 0 | 1, 6 | 0 | 1 | 3 | 4 |
| 141 | A2/B2 | 1 | 0 | 4, 9 | 0 | 1 | 3 | 4 |
| 142 | A2/B2 | 1 | 0 | 1 | 0 | 2 | 3 | 4 |
| 143 | A2/B2 | 1 | 0 | 7 | 0 | 2 | 3 | 4 |
| 144 | A2/B2 | 1 | 0 | 1, 4, 7 | 0 | 2 | 3 | 4 |
| 145 | A2/B2 | 1 | 0 | 0, 2, 4, 6, 8 | 0 | 2 | 3 | 4 |
| 146 | A2/B2 | 1 | 0 | 0, 1, 2, 3, 4, | 0 | 2 | 3 | 4 |
| | | | | 5, 6, 7, 8, 9 | | | | |
| 147 | A3 | 16 | 1 | 4, 9 | 0 | 1 | 2 | 6 |
| 148 | A3 | 16 | 1 | 4 | 0 | 2 | 2 | 6 |
| 149 | A3 | 8 | 1 | 4, 9 | 0 | 1 | 2 | 6 |
| 150 | A3 | 8 | 1 | 4 | 0 | 2 | 2 | 6 |
| 151 | A3 | 4 | 0 | 4, 9 | 0 | 1 | 2 | 6 |
| 152 | A3 | 4 | 0 | 4 | 0 | 2 | 2 | 6 |
| 153 | A3 | 2 | 1 | 2, 6, 9 | 0 | 2 | 2 | 6 |
| 154 | A3 | 2 | 0 | 1 | 0 | 2 | 2 | 6 |
| 155 | A3 | 2 | 0 | 4 | 0 | 2 | 2 | 6 |
| 156 | A3 | 2 | 0 | 7 | 0 | 2 | 2 | 6 |
| 157 | A3 | 1 | 0 | 4 | 0 | 1 | 2 | 6 |
| 158 | A3 | 1 | 0 | 1, 6 | 0 | 1 | 2 | 6 |
| 159 | A3 | 1 | 0 | 4, 9 | 0 | 1 | 2 | 6 |
| 160 | A3 | 1 | 0 | 1 | 0 | 2 | 2 | 6 |
| 161 | A3 | 1 | 0 | 7 | 0 | 2 | 2 | 6 |
| 162 | A3 | 1 | 0 | 2, 7 | 0 | 2 | 2 | 6 |
| 163 | A3 | 1 | 0 | 1, 4, 7 | 0 | 2 | 2 | 6 |
| 164 | A3 | 1 | 0 | 0, 2, 4, 6, 8 | 0 | 2 | 2 | 6 |
| 165 | A3 | 1 | 0 | 0, 1, 2, 3, 4, | 0 | 2 | 2 | 6 |
| | | | | 5, 6, 7, 8, 9 | | | | |
| 166 | A3 | 1 | 0 | 1, 3, 5, 7, 9 | 0 | 2 | 2 | 6 |
| 167 | A3/B3 | 2 | 1 | 2, 6, 9 | 0 | 2 | 2 | 6 |
| 168 | A3/B3 | 2 | 0 | 4 | 0 | 2 | 2 | 6 |
| 169 | A3/B3 | 1 | 0 | 4 | 0 | 1 | 2 | 6 |
| 170 | A3/B3 | 1 | 0 | 1, 6 | 0 | 1 | 2 | 6 |
| 171 | A3/B3 | 1 | 0 | 4, 9 | 0 | 1 | 2 | 6 |
| 172 | A3/B3 | 1 | 0 | 1 | 0 | 2 | 2 | 6 |
| 173 | A3/B3 | 1 | 0 | 7 | 0 | 2 | 2 | 6 |
| 174 | A3/B3 | 1 | 0 | 1, 4, 7 | 0 | 2 | 2 | 6 |
| 175 | A3/B3 | 1 | 0 | 0, 2, 4, 6, 8 | 0 | 2 | 2 | 6 |
| 176 | A3/B3 | 1 | 0 | 0, 1, 2, 3, 4, | 0 | 2 | 2 | 6 |
| | | | | 5, 6, 7, 8, 9 | | | | |
| 177 | B1 | 16 | 0 | 4, 9 | 0 | 1 | 7 | 2 |
| 178 | B1 | 16 | 1 | 4 | 0 | 2 | 7 | 2 |
| 179 | B1 | 8 | 0 | 4, 9 | 0 | 1 | 7 | 2 |
| 180 | B1 | 8 | 1 | 4 | 0 | 2 | 7 | 2 |
| 181 | B1 | 4 | 0 | 4, 9 | 0 | 1 | 7 | 2 |
| 182 | B1 | 4 | 1 | 4, 9 | 0 | 1 | 7 | 2 |
| 183 | B1 | 4 | 0 | 4 | 0 | 2 | 7 | 2 |
| 184 | B1 | 2 | 0 | 4, 9 | 0 | 1 | 7 | 2 |
| 185 | B1 | 2 | 0 | 1 | 0 | 2 | 7 | 2 |
| 186 | B1 | 2 | 0 | 4 | 0 | 2 | 7 | 2 |
| 187 | B1 | 2 | 0 | 7 | 0 | 2 | 7 | 2 |
| 188 | B1 | 1 | 0 | 4 | 0 | 1 | 7 | 2 |
| 189 | B1 | 1 | 0 | 1, 6 | 0 | 1 | 7 | 2 |
| 190 | B1 | 1 | 0 | 4, 9 | 0 | 1 | 7 | 2 |
| 191 | B1 | 1 | 0 | 1 | 0 | 2 | 7 | 2 |
| 192 | B1 | 1 | 0 | 7 | 0 | 2 | 7 | 2 |
| 193 | B1 | 1 | 0 | 2, 7 | 0 | 2 | 7 | 2 |
| 194 | B1 | 1 | 0 | 1, 4, 7 | 0 | 2 | 7 | 2 |
| 195 | B1 | 1 | 0 | 0, 2, 4, 6, 8 | 0 | 2 | 7 | 2 |
| 196 | B1 | 1 | 0 | 0, 1, 2, 3, 4, | 0 | 2 | 7 | 2 |
| | | | | 5, 6, 7, 8, 9 | | | | |
| 197 | B1 | 1 | 0 | 1, 3, 5, 7, 9 | 0 | 2 | 7 | 2 |
| 198 | B4 | 16 | 0 | 4, 9 | 0 | 2 | 1 | 12 |
| 199 | B4 | 16 | 1 | 4 | 0 | 2 | 1 | 12 |
| 200 | B4 | 8 | 0 | 4, 9 | 0 | 2 | 1 | 12 |
| 201 | B4 | 8 | 1 | 4 | 0 | 2 | 1 | 12 |
| 202 | B4 | 4 | 0 | 4, 9 | 0 | 2 | 1 | 12 |
| 203 | B4 | 4 | 0 | 4 | 0 | 2 | 1 | 12 |
| 204 | B4 | 4 | 1 | 4, 9 | 0 | 2 | 1 | 12 |
| 205 | B4 | 2 | 0 | 4, 9 | 0 | 2 | 1 | 12 |
| 206 | B4 | 2 | 0 | 1 | 0 | 2 | 1 | 12 |
| 207 | B4 | 2 | 0 | 4 | 0 | 2 | 1 | 12 |
| 208 | B4 | 2 | 0 | 7 | 0 | 2 | 1 | 12 |
| 209 | B4 | 1 | 0 | 1 | 0 | 2 | 1 | 12 |
| 210 | B4 | 1 | 0 | 4 | 0 | 2 | 1 | 12 |
| 211 | B4 | 1 | 0 | 7 | 0 | 2 | 1 | 12 |
| 212 | B4 | 1 | 0 | 1, 6 | 0 | 2 | 1 | 12 |
| 213 | B4 | 1 | 0 | 2, 7 | 0 | 2 | 1 | 12 |
| 214 | B4 | 1 | 0 | 4, 9 | 0 | 2 | 1 | 12 |
| 215 | B4 | 1 | 0 | 1, 4, 7 | 0 | 2 | 1 | 12 |
| 216 | B4 | 1 | 0 | 0, 2, 4, 6, 8 | 0 | 2 | 1 | 12 |
| 217 | B4 | 1 | 0 | 0, 1, 2, 3, 4, | 0 | 2 | 1 | 12 |
| | | | | 5, 6, 7, 8, 9 | | | | |
| 218 | B4 | 1 | 0 | 1, 3, 5, 7, 9 | 0 | 2 | 1 | 12 |
| 219 | C0 | 8 | 1 | 4 | 0 | 2 | 7 | 2 |
| 220 | C0 | 4 | 1 | 4, 9 | 0 | 1 | 7 | 2 |
| 221 | C0 | 4 | 0 | 4 | 0 | 2 | 7 | 2 |
| 222 | C0 | 2 | 0 | 4, 9 | 0 | 1 | 7 | 2 |
| 223 | C0 | 2 | 0 | 1 | 0 | 2 | 7 | 2 |
| 224 | C0 | 2 | 0 | 4 | 0 | 2 | 7 | 2 |
| 225 | C0 | 2 | 0 | 7 | 0 | 2 | 7 | 2 |
| 226 | C0 | 1 | 0 | 4 | 0 | 1 | 7 | 2 |
| 227 | C0 | 1 | 0 | 1, 6 | 0 | 1 | 7 | 2 |
| 228 | C0 | 1 | 0 | 4, 9 | 0 | 1 | 7 | 2 |
| 229 | C0 | 1 | 0 | 1 | 0 | 2 | 7 | 2 |
| 230 | C0 | 1 | 0 | 7 | 0 | 2 | 7 | 2 |
| 231 | C0 | 1 | 0 | 2, 7 | 0 | 2 | 7 | 2 |
| 232 | C0 | 1 | 0 | 1, 4, 7 | 0 | 2 | 7 | 2 |
| 233 | C0 | 1 | 0 | 0, 2, 4, 6, 8 | 0 | 2 | 7 | 2 |
| 234 | C0 | 1 | 0 | 0, 1, 2, 3, 4, | 0 | 2 | 7 | 2 |
| | | | | 5, 6, 7, 8, 9 | | | | |
| 235 | C0 | 1 | 0 | 1, 3, 5, 7, 9 | 0 | 2 | 7 | 2 |
| 236 | C2 | 16 | 1 | 4, 9 | 0 | 1 | 2 | 6 |
| 237 | C2 | 16 | 1 | 4 | 0 | 2 | 2 | 6 |
| 238 | C2 | 8 | 1 | 4, 9 | 0 | 1 | 2 | 6 |
| 239 | C2 | 8 | 1 | 4 | 0 | 2 | 2 | 6 |
| 240 | C2 | 4 | 0 | 4, 9 | 0 | 1 | 2 | 6 |
| 241 | C2 | 4 | 0 | 4 | 0 | 2 | 2 | 6 |
| 242 | C2 | 2 | 1 | 2, 6, 9 | 0 | 2 | 2 | 6 |
| 243 | C2 | 2 | 0 | 1 | 0 | 2 | 2 | 6 |
| 244 | C2 | 2 | 0 | 4 | 0 | 2 | 2 | 6 |
| 245 | C2 | 2 | 0 | 7 | 0 | 2 | 2 | 6 |
| 246 | C2 | 1 | 0 | 4 | 0 | 1 | 2 | 6 |
| 247 | C2 | 1 | 0 | 1, 6 | 0 | 1 | 2 | 6 |
| 248 | C2 | 1 | 0 | 4, 9 | 0 | 1 | 2 | 6 |
| 249 | C2 | 1 | 0 | 1 | 0 | 2 | 2 | 6 |
| 250 | C2 | 1 | 0 | 7 | 0 | 2 | 2 | 6 |
| 251 | C2 | 1 | 0 | 2, 7 | 0 | 2 | 2 | 6 |
| 252 | C2 | 1 | 0 | 1, 4, 7 | 0 | 2 | 2 | 6 |
| 253 | C2 | 1 | 0 | 0, 2, 4, 6, 8 | 0 | 2 | 2 | 6 |
| 254 | C2 | 1 | 0 | 0, 1, 2, 3, 4, | 0 | 2 | 2 | 6 |
| | | | | 5, 6, 7, 8, 9 | | | | |
| 255 | C2 | 1 | 0 | 1, 3, 5, | 0 | 2 | 2 | 6 |
| | | | | 7, 9 | | | | |

TABLE 3
Table 6.3.3.2-3: Random access configurations for FR1 and unpaired spectrum.

| | | | | | | | N^{RA,slot}, | |
|---|---|---|---|---|---|---|---|---|
| | | | | | | | number | |
| | | | | | | | of | |
| | | | | | | | time- | |
| | | | | | | | domain | |
| | | | | | | | PRACH | |
| | | | | | | Number | ccasions | |
| | | | | | | of | within | |
| PRACH | | | | | | PRACH | a | N_{dur}^{RA}, |
| Configuration | Preamble | n_{SFN}^{modx} = y | | Subframe | Starting | within a | PRACH | PRACH |
| index | format | x | y | number | symbol | subframe | slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |
| 10 | 0 | 1 | 0 | 6 | 0 | — | — | 0 |
| 11 | 0 | 1 | 0 | 5 | 0 | — | — | 0 |
| 12 | 0 | 1 | 0 | 4 | 0 | — | — | 0 |
| 13 | 0 | 1 | 0 | 3 | 0 | — | — | 0 |
| 14 | 0 | 1 | 0 | 2 | 0 | — | — | 0 |
| 15 | 0 | 1 | 0 | 1, 6 | 0 | — | — | 0 |
| 16 | 0 | 1 | 0 | 1, 6 | 7 | — | — | 0 |
| 17 | 0 | 1 | 0 | 4, 9 | 0 | — | — | 0 |
| 18 | 0 | 1 | 0 | 3, 8 | 0 | — | — | 0 |
| 19 | 0 | 1 | 0 | 2, 7 | 0 | — | — | 0 |
| 20 | 0 | 1 | 0 | 8, 9 | 0 | — | — | 0 |
| 21 | 0 | 1 | 0 | 4, 8, 9 | 0 | — | — | 0 |
| 22 | 0 | 1 | 0 | 3, 4, 9 | 0 | — | — | 0 |
| 23 | 0 | 1 | 0 | 7, 8, 9 | 0 | — | — | 0 |
| 24 | 0 | 1 | 0 | 3, 4, 8, 9 | 0 | — | — | 0 |
| 25 | 0 | 1 | 0 | 6, 7, 8, 9 | 0 | — | — | 0 |
| 26 | 0 | 1 | 0 | 1, 4, 6, 9 | 0 | — | — | 0 |
| 27 | 0 | 1 | 0 | 1, 3, 5, 7, 9 | 0 | — | — | 0 |
| 28 | 1 | 16 | 1 | 7 | 0 | — | — | 0 |
| 29 | 1 | 8 | 1 | 7 | 0 | — | — | 0 |
| 30 | 1 | 4 | 1 | 7 | 0 | — | — | 0 |
| 31 | 1 | 2 | 0 | 7 | 0 | — | — | 0 |
| 32 | 1 | 2 | 1 | 7 | 0 | — | — | 0 |
| 33 | 1 | 1 | 0 | 7 | 0 | — | — | 0 |
| 34 | 2 | 16 | 1 | 6 | 0 | — | — | 0 |
| 35 | 2 | 8 | 1 | 6 | 0 | — | — | 0 |
| 36 | 2 | 4 | 1 | 6 | 0 | — | — | 0 |
| 37 | 2 | 2 | 0 | 6 | 7 | — | — | 0 |
| 38 | 2 | 2 | 1 | 6 | 7 | — | — | 0 |
| 39 | 2 | 1 | 0 | 6 | 7 | — | — | 0 |
| 40 | 3 | 16 | 1 | 9 | 0 | — | — | 0 |
| 41 | 3 | 8 | 1 | 9 | 0 | — | — | 0 |
| 42 | 3 | 4 | 1 | 9 | 0 | — | — | 0 |
| 43 | 3 | 2 | 0 | 9 | 0 | — | — | 0 |
| 44 | 3 | 2 | 1 | 9 | 0 | — | — | 0 |
| 45 | 3 | 2 | 0 | 4 | 0 | — | — | 0 |
| 46 | 3 | 2 | 1 | 4 | 0 | — | — | 0 |
| 47 | 3 | 1 | 0 | 9 | 0 | — | — | 0 |
| 48 | 3 | 1 | 0 | 8 | 0 | — | — | 0 |
| 49 | 3 | 1 | 0 | 7 | 0 | — | — | 0 |
| 50 | 3 | 1 | 0 | 6 | 0 | — | — | 0 |
| 51 | 3 | 1 | 0 | 5 | 0 | — | — | 0 |
| 52 | 3 | 1 | 0 | 4 | 0 | — | — | 0 |
| 53 | 3 | 1 | 0 | 3 | 0 | — | — | 0 |
| 54 | 3 | 1 | 0 | 2 | 0 | — | — | 0 |
| 55 | 3 | 1 | 0 | 1, 6 | 0 | — | — | 0 |
| 56 | 3 | 1 | 0 | 1, 6 | 7 | — | — | 0 |
| 57 | 3 | 1 | 0 | 4, 9 | 0 | — | — | 0 |
| 58 | 3 | 1 | 0 | 3, 8 | 0 | — | — | 0 |
| 59 | 3 | 1 | 0 | 2, 7 | 0 | — | — | 0 |
| 60 | 3 | 1 | 0 | 8, 9 | 0 | — | — | 0 |
| 61 | 3 | 1 | 0 | 4, 8, 9 | 0 | — | — | 0 |
| 62 | 3 | 1 | 0 | 3, 4, 9 | 0 | — | — | 0 |
| 63 | 3 | 1 | 0 | 7, 8, 9 | 0 | — | — | 0 |
| 64 | 3 | 1 | 0 | 3, 4, 8, 9 | 0 | — | — | 0 |
| 65 | 3 | 1 | 0 | 1, 4, 6, 9 | 0 | — | — | 0 |
| 66 | 3 | 1 | 0 | 1, 3, 5, 7, 9 | 0 | — | — | 0 |
| 67 | A1 | 16 | 1 | 9 | 0 | 2 | 6 | 2 |
| 68 | A1 | 8 | 1 | 9 | 0 | 2 | 6 | 2 |
| 69 | A1 | 4 | 1 | 9 | 0 | 1 | 6 | 2 |
| 70 | A1 | 2 | 1 | 9 | 0 | 1 | 6 | 2 |
| 71 | A1 | 2 | 1 | 4, 9 | 7 | 1 | 3 | 2 |
| 72 | A1 | 2 | 1 | 7, 9 | 7 | 1 | 3 | 2 |
| 73 | A1 | 2 | 1 | 7, 9 | 0 | 1 | 6 | 2 |
| 74 | A1 | 2 | 1 | 8, 9 | 0 | 2 | 6 | 2 |
| 75 | A1 | 2 | 1 | 4, 9 | 0 | 2 | 6 | 2 |
| 76 | A1 | 2 | 1 | 2, 3, 4, 7, 8, 9 | 0 | 1 | 6 | 2 |
| 77 | A1 | 1 | 0 | 9 | 0 | 2 | 6 | 2 |
| 78 | A1 | 1 | 0 | 9 | 7 | 1 | 3 | 2 |
| 79 | A1 | 1 | 0 | 9 | 0 | 1 | 6 | 2 |
| 80 | A1 | 1 | 0 | 8, 9 | 0 | 2 | 6 | 2 |
| 81 | A1 | 1 | 0 | 4, 9 | 0 | 1 | 6 | 2 |
| 82 | A1 | 1 | 0 | 7, 9 | 7 | 1 | 3 | 2 |
| 83 | A1 | 1 | 0 | 3, 4, 8, 9 | 0 | 1 | 6 | 2 |
| 84 | A1 | 1 | 0 | 3, 4, 8, 9 | 0 | 2 | 6 | 2 |
| 85 | A1 | 1 | 0 | 1, 3, 5, 7, 9 | 0 | 1 | 6 | 2 |
| 86 | A | 1 | 0 | 0, 1, 2, 3, 4, | 7 | 1 | 3 | 2 |
| | | | | 5, 6, 7, 8, 9 | | | | |
| 87 | A2 | 16 | 1 | 9 | 0 | 2 | 3 | 4 |
| 88 | A2 | 8 | 1 | 9 | 0 | 2 | 3 | 4 |
| 89 | A2 | 4 | 1 | 9 | 0 | 1 | 3 | 4 |
| 90 | A2 | 2 | 1 | 7, 9 | 0 | 1 | 3 | 4 |
| 91 | A2 | 2 | 1 | 8, 9 | 0 | 2 | 3 | 4 |
| 92 | A2 | 2 | 1 | 7, 9 | 9 | 1 | 1 | 4 |
| 93 | A2 | 2 | 1 | 4, 9 | 9 | 1 | 1 | 4 |
| 94 | A2 | 2 | 1 | 4, 9 | 0 | 2 | 3 | 4 |
| 95 | A2 | 2 | 1 | 2, 3, 4, 7, | 0 | 1 | 3 | 4 |
| | | | | 8, 9 | | | | |
| 96 | A2 | 1 | 0 | 2 | 0 | 1 | 3 | 4 |
| 97 | A2 | 1 | 0 | 7 | 0 | 1 | 3 | 4 |
| 98 | A2 | 2 | 1 | 9 | 0 | 1 | 3 | 4 |
| 99 | A2 | 1 | 0 | 9 | 0 | 2 | 3 | 4 |
| 100 | A2 | 1 | 0 | 9 | 9 | 1 | 1 | 4 |
| 101 | A2 | 1 | 0 | 9 | 0 | 1 | 3 | 4 |
| 102 | A2 | 1 | 0 | 2, 7 | 0 | 1 | 3 | 4 |
| 103 | A2 | 1 | 0 | 8, 9 | 0 | 2 | 3 | 4 |
| 104 | A2 | 1 | 0 | 4, 9 | 0 | 1 | 3 | 4 |
| 105 | A2 | 1 | 0 | 7, 9 | 9 | 1 | 1 | 4 |
| 106 | A2 | 1 | 0 | 3, 4, 8, 9 | 0 | 1 | 3 | 4 |
| 107 | A2 | 1 | 0 | 3, 4, 8, 9 | 0 | 2 | 3 | 4 |
| 108 | A2 | 1 | 0 | 1, 3, 5, 7, 9 | 0 | 1 | 3 | 4 |
| 109 | A2 | 1 | 0 | 0, 1, 2, 3, | 9 | 1 | 1 | 4 |
| | | | | 4, 5, 6, 7, | | | | |
| | | | | 8, 9 | | | | |
| 110 | A3 | 16 | 1 | 9 | 0 | 2 | 2 | 6 |
| 111 | A3 | 8 | 1 | 9 | 0 | 2 | 2 | 6 |
| 112 | A3 | 4 | 1 | 9 | 0 | 1 | 2 | 6 |
| 113 | A3 | 2 | 1 | 4, 9 | 7 | 1 | 1 | 6 |
| 114 | A3 | 2 | 1 | 7, 9 | 7 | 1 | 1 | 6 |
| 115 | A3 | 2 | 1 | 7, 9 | 0 | 1 | 2 | 6 |
| 116 | A3 | 2 | 1 | 4, 9 | 0 | 2 | 2 | 6 |
| 117 | A3 | 2 | 1 | 8, 9 | 0 | 2 | 2 | 6 |
| 118 | A3 | 2 | 1 | 2, 3, 4, 7, | 0 | 1 | 2 | 6 |
| | | | | 8, 9 | | | | |
| 119 | A3 | 1 | 0 | 2 | 0 | 1 | 2 | 6 |
| 120 | A3 | 1 | 0 | 7 | 0 | 1 | 2 | 6 |
| 121 | A3 | 2 | 1 | 9 | 0 | 1 | 2 | 6 |
| 122 | A3 | 1 | 0 | 9 | 0 | 2 | 2 | 6 |
| 123 | A3 | 1 | 0 | 9 | 7 | 1 | 1 | 6 |
| 124 | A3 | 1 | 0 | 9 | 0 | 1 | 2 | 6 |
| 125 | A3 | 1 | 0 | 2, 7 | 0 | 1 | 2 | 6 |
| 126 | A3 | 1 | 0 | 8, 9 | 0 | 2 | 2 | 6 |
| 127 | A3 | 1 | 0 | 4, 9 | 0 | 1 | 2 | 6 |
| 128 | A3 | 1 | 0 | 7, 9 | 7 | 1 | 1 | 6 |
| 129 | A3 | 1 | 0 | 3, 4, 8, 9 | 0 | 1 | 2 | 6 |
| 130 | A3 | 1 | 0 | 3, 4, 8, 9 | 0 | 2 | 2 | 6 |
| 131 | A3 | 1 | 0 | 1, 3, 5, 7, 9 | 0 | 1 | 2 | 6 |
| 132 | A3 | 1 | 0 | 0, 1, 2, 3, 4, | | 7 | | 1 |
| | | | | 5, 6, 7, 8, 9 | | | | |
| 133 | B1 | 4 | 1 | 9 | 2 | 1 | 6 | 2 |
| 134 | B1 | 2 | 1 | 9 | 2 | 1 | 6 | 2 |
| 135 | B1 | 2 | 1 | 7, 9 | 2 | 1 | 6 | 2 |
| 136 | B1 | 2 | 1 | 4, 9 | 8 | 1 | 3 | 2 |
| 137 | B1 | 2 | 1 | 4, 9 | 2 | 2 | 6 | 2 |
| 138 | B1 | 1 | 0 | 9 | 2 | 2 | 6 | 2 |
| 139 | B1 | 1 | 0 | 9 | 8 | 1 | 3 | 2 |
| 140 | B1 | 1 | 0 | 9 | 2 | 1 | 6 | 2 |
| 141 | B1 | 1 | 0 | 8, 9 | 2 | 2 | 6 | 2 |
| 142 | B1 | 1 | 0 | 4, 9 | 2 | 1 | 6 | 2 |
| 143 | B1 | 1 | 0 | 7, 9 | 8 | 1 | 3 | 2 |
| 144 | B1 | 1 | 0 | 1, 3, 5, 7, 9 | 2 | 1 | 6 | 2 |
| 145 | B4 | 16 | 1 | 9 | 0 | 2 | 1 | 12 |
| 146 | B4 | 8 | 1 | 9 | 0 | 2 | 1 | 12 |
| 147 | B4 | 4 | 1 | 9 | 2 | 1 | 1 | 12 |
| 148 | B4 | 2 | 1 | 9 | 0 | 1 | 1 | 12 |
| 149 | B4 | 2 | 1 | 9 | 2 | 1 | 1 | 12 |
| 150 | B4 | 2 | 1 | 7, 9 | 2 | 1 | 1 | 12 |
| 151 | B4 | 2 | 1 | 4, 9 | 2 | 1 | 1 | 12 |
| 152 | B4 | 2 | 1 | 4, 9 | 0 | 2 | 1 | 12 |
| 153 | B4 | 2 | 1 | 8, 9 | 0 | 2 | 1 | 12 |
| 154 | B4 | 2 | 1 | 2, 3, 4, 7, 8, 9 | 0 | 1 | 1 | 12 |
| 155 | B4 | 1 | 0 | 1 | 0 | 1 | 1 | 12 |
| 156 | B4 | 1 | 0 | 2 | 0 | 1 | 1 | 12 |
| 157 | B4 | 1 | 0 | 4 | 0 | 1 | 1 | 12 |
| 158 | B4 | 1 | 0 | 7 | 0 | 1 | 1 | 12 |
| 159 | B4 | 1 | 0 | 9 | 0 | 1 | 1 | 12 |
| 160 | B4 | 1 | 0 | 9 | 2 | 1 | 1 | 12 |
| 161 | B4 | 1 | 0 | 9 | 0 | 2 | 1 | 12 |
| 162 | B4 | 1 | 0 | 4, 9 | 2 | 1 | 1 | 12 |
| 163 | B4 | 1 | 0 | 7, 9 | 2 | 1 | 1 | 12 |
| 164 | B4 | 1 | 0 | 8, 9 | 0 | 2 | 1 | 12 |
| 165 | B4 | 1 | 0 | 3, 4, 8, 9 | 2 | 1 | 1 | 12 |
| 166 | B4 | 1 | 0 | 1, 3, 5, 7, 9 | 2 | 1 | 1 | 12 |
| 167 | B4 | 1 | 0 | 0, 1, 2, 3, 4, | 0 | 2 | 1 | 12 |
| | | | | 5, 6, 7, 8, 9 | | | | |
| 168 | B4 | 1 | 0 | 0, 1, 2, 3, 4, | 2 | 1 | 1 | 12 |
| | | | | 5, 6, 7, 8, 9 | | | | |
| 169 | C0 | 16 | 1 | 9 | 2 | 2 | 6 | 2 |
| 170 | CO | 8 | 1 | 9 | 2 | 2 | 6 | 2 |
| 171 | CO | 4 | 1 | 9 | 2 | 1 | 6 | 2 |
| 172 | CO | 2 | 1 | 9 | 2 | 1 | 6 | 2 |
| 173 | CO | 2 | 1 | 8, 9 | 2 | 2 | 6 | 2 |
| 174 | CO | 2 | 1 | 7, 9 | 2 | 1 | 6 | 2 |
| 175 | CO | 2 | 1 | 7, 9 | 8 | 1 | 3 | 2 |
| 176 | CO | 2 | 1 | 4, 9 | 8 | 1 | 3 | 2 |
| 177 | CO | 2 | 1 | 4, 9 | 2 | 2 | 6 | 2 |
| 178 | CO | 2 | 1 | 2, 3, 4, | 2 | 1 | 6 | 2 |
| | | | | 7, 8, 9 | | | | |
| 179 | C0 | 1 | 0 | 9 | 2 | 2 | 6 | 2 |
| 180 | CO | 1 | 0 | 9 | 8 | 1 | 3 | 2 |
| 181 | CO | 1 | 0 | 9 | 2 | 1 | 6 | 2 |
| 182 | CO | 1 | 0 | 8, 9 | 2 | 2 | 6 | 2 |
| 183 | CO | 1 | 0 | 4, 9 | 2 | 1 | 6 | 2 |
| 184 | CO | 1 | 0 | 7, 9 | 8 | 1 | 3 | 2 |
| 185 | CO | 1 | 0 | 3, 4, 8, 9 | 2 | 1 | 6 | 2 |
| 186 | CO | 1 | 0 | 3, 4, 8, 9 | 2 | 2 | 6 | 2 |
| 187 | CO | 1 | 0 | 1, 3, 5, 7, 9 | 2 | 1 | 6 | 2 |
| 188 | CO | 1 | 0 | 0, 1, 2, 3, 4, | 8 | 1 | 3 | 2 |
| | | | | 5, 6, 7, 8, 9 | | | | |
| 189 | C2 | 16 | 1 | 9 | 2 | 2 | 2 | 6 |
| 190 | C2 | 8 | 1 | 9 | 2 | 2 | 2 | 6 |
| 191 | C2 | 4 | 1 | 9 | 2 | 1 | 2 | 6 |
| 192 | C2 | 2 | 1 | 9 | 2 | 1 | 2 | 6 |
| 193 | C2 | 2 | 1 | 8, 9 | 2 | 2 | 2 | 6 |
| 194 | C2 | 2 | 1 | 7, 9 | 2 | 1 | 2 | 6 |
| 195 | C2 | 2 | 1 | 7, 9 | 8 | 1 | 1 | 6 |
| 196 | C2 | 2 | 1 | 4, 9 | 8 | 1 | 1 | 6 |
| 197 | C2 | 2 | 1 | 4, 9 | 2 | 2 | 2 | 6 |
| 198 | C2 | 2 | 1 | 2, 3, 4, 7, | 2 | 1 | 2 | 6 |
| | | | | 8, 9 | | | | |
| 199 | C2 | 8 | 1 | 9 | 8 | 2 | 1 | 6 |
| 200 | C2 | 4 | 1 | 9 | 8 | 1 | 1 | 6 |
| 201 | C2 | 1 | 0 | 9 | 2 | 2 | 2 | 6 |
| 202 | C2 | 1 | 0 | 9 | 8 | 1 | 1 | 6 |
| 203 | C2 | 1 | 0 | 9 | 2 | 1 | 2 | 6 |
| 204 | C2 | 1 | 0 | 8, 9 | 2 | 2 | 2 | 6 |
| 205 | C2 | 1 | 0 | 4, 9 | 2 | 1 | 2 | 6 |
| 206 | C2 | 1 | 0 | 7, 9 | 8 | 1 | 1 | 6 |
| 207 | C2 | 1 | 0 | 3, 4, 8, 9 | 2 | 1 | 2 | 6 |
| 208 | C2 | 1 | 0 | 3, 4, 8, 9 | 2 | 2 | 2 | 6 |
| 209 | C2 | 1 | 0 | 1, 3, 5, 7, 9 | 2 | 1 | 2 | 6 |
| 210 | C2 | 1 | 0 | 0, 1, 2, 3, 4, | 8 | 1 | 1 | 6 |
| | | | | 5, 6, 7, 8, 9 | | | | |
| 211 | A1/B1 | 2 | 1 | 9 | 2 | 1 | 6 | 2 |
| 212 | A1/B1 | 2 | 1 | 4, 9 | 8 | 1 | 3 | 2 |
| 213 | A1/B1 | 2 | 1 | 7, 9 | 8 | 1 | 3 | 2 |
| 214 | A1/B1 | 2 | 1 | 7, 9 | 2 | 1 | 6 | 2 |
| 215 | A1/B1 | 2 | 1 | 4, 9 | 2 | 2 | 6 | 2 |
| 216 | A1/B1 | 2 | 1 | 8, 9 | 2 | 2 | 6 | 2 |
| 217 | A1/B1 | 1 | 0 | 9 | 2 | 2 | 6 | 2 |
| 218 | A1/B1 | 1 | 0 | 9 | 8 | 1 | 3 | 2 |
| 219 | A1/B1 | 1 | 0 | 9 | 2 | 1 | 6 | 2 |
| 220 | A1/B1 | 1 | 0 | 8, 9 | 2 | 2 | 6 | 2 |
| 221 | A1/B1 | 1 | 0 | 4, 9 | 2 | 1 | 6 | 2 |
| 222 | A1/B1 | 1 | 0 | 7, 9 | 8 | 1 | 3 | 2 |
| 223 | A1/B1 | 1 | 0 | 3, 4, 8, 9 | 2 | 2 | 6 | 2 |
| 224 | A1/B1 | 1 | 0 | 1, 3, 5, 7, 9 | 2 | 1 | 6 | 2 |
| 225 | A1/B1 | 1 | 0 | 0, 1, 2, 3, 4, | 8 | 1 | 3 | 2 |
| | | | | 5, 6, 7, 8, 9 | | | | |
| 226 | A2/B2 | 2 | 1 | 9 | 0 | 1 | 3 | 4 |
| 227 | A2/B2 | 2 | 1 | 4, 9 | 6 | 1 | 2 | 4 |
| 228 | A2/B2 | 2 | 1 | 7, 9 | 6 | 1 | 2 | 4 |
| 229 | A2/B2 | 2 | 1 | 4, 9 | 0 | 2 | 3 | 4 |
| 230 | A2/B2 | 2 | 1 | 8, 9 | 0 | 2 | 3 | 4 |
| 231 | A2/B2 | 1 | 0 | 9 | 0 | 2 | 3 | 4 |
| 232 | A2/B2 | 1 | 0 | 9 | 6 | 1 | 2 | 4 |
| 233 | A2/B2 | 1 | 0 | 9 | 0 | 1 | 3 | 4 |
| 234 | A2/B2 | 1 | 0 | 8, 9 | 0 | 2 | 3 | 4 |
| 235 | A2/B2 | 1 | 0 | 4, 9 | 0 | 1 | 3 | 4 |
| 236 | A2/B2 | 1 | 0 | 7, 9 | 6 | 1 | 2 | 4 |
| 237 | A2/B2 | 1 | 0 | 3, 4, 8, 9 | 0 | 1 | 3 | 4 |
| 238 | A2/B2 | 1 | 0 | 3, 4, 8, 9 | 0 | 2 | 3 | 4 |
| 239 | A2/B2 | 1 | 0 | 1, 3, 5, 7, 9 | 0 | 1 | 3 | 4 |
| 240 | A2/B2 | 1 | 0 | 0, 1, 2, 3, 4, | 6 | 1 | 2 | 4 |
| | | | | 5, 6, 7, 8, 9 | | | | |
| 241 | A3/B3 | 2 | 1 | 9 | 0 | 1 | 2 | 6 |
| 242 | A3/B3 | 2 | 1 | 4, 9 | 2 | 1 | 2 | 6 |
| 243 | A3/B3 | 2 | 1 | 7, 9 | 0 | 1 | 2 | 6 |
| 244 | A3/B3 | 2 | 1 | 7, 9 | 2 | 1 | 2 | 6 |
| 245 | A3/B3 | 2 | 1 | 4, 9 | 0 | 2 | 2 | 6 |
| 246 | A3/B3 | 2 | 1 | 8, 9 | 0 | 2 | 2 | 6 |
| 247 | A3/B3 | 1 | 0 | 9 | 0 | 2 | 2 | 6 |
| 248 | A3/B3 | 1 | 0 | 9 | 2 | 1 | 2 | 6 |
| 249 | A3/B3 | 1 | 0 | 9 | 0 | 1 | 2 | 6 |
| 250 | A3/B3 | 1 | 0 | 8, 9 | 0 | 2 | 2 | 6 |
| 251 | A3/B3 | 1 | 0 | 4, 9 | 0 | 1 | 2 | 6 |
| 252 | A3/B3 | 1 | 0 | 7, 9 | 2 | 1 | 2 | 6 |
| 253 | A3/B3 | 1 | 0 | 3, 4, 8, 9 | 0 | 2 | 2 | 6 |
| 254 | A3/B3 | 1 | 0 | 1, 3, 5, 7, 9 | 0 | 1 | 2 | 6 |
| 255 | A3/B3 | 1 | 0 | 0, 1, 2, 3, 4, | 2 | 1 | 2 | 6 |
| | | | | 5, 6, 7, 8, 9 | | | | |
| 256 | 0 | 16 | 1 | 7 | 0 | — | — | 0 |
| 257 | 0 | 8 | 1 | 7 | 0 | — | — | 0 |
| 258 | 0 | 4 | 1 | 7 | 0 | — | — | 0 |
| 259 | 0 | 2 | 0 | 7 | 0 | — | — | 0 |
| 260 | 0 | 2 | 1 | 7 | 0 | — | — | 0 |
| 261 | 0 | 2 | 0 | 2 | 0 | — | — | 0 |
| 262 | 0 | 2 | 1 | 2 | 0 | — | — | 0 |

TABLE 4
Table 6.3.3.2-4: Random access configurations for FR2 and unpaired spectrum.

| | | |
|---|---|---|
| | | N^{RA, slot}, |
| | | number |
| | | of |
| | | time- |
| | Number | domain |
| | of | PRACH |
| | PRACH | ccasions |
| PRACH | slots | within |

| Config- | | | | | | within | a | N^{RA}_{dur}, |
|---|---|---|---|---|---|---|---|---|
| uration | Preamble | N_{SFN}modx = y | | Subframe | Starting | a | PRACH | PRACH |
| index | format | x | y | number | symbol | subframe | slot | duration |
| 0 | A1 | 16 | 1 | 4, 9, 14, 19, | 0 | 2 | 6 | 2 |
| | | | | 24, 29, 34, | | | | |
| | | | | 39 | | | | |
| 1 | A1 | 16 | 1 | 3, 7, 11, 15, | 0 | 1 | 6 | 2 |
| | | | | 19, 23, 27, | | | | |
| | | | | 31, 35, 39 | | | | |
| 2 | A1 | 8 | 1, 2 | 9, 19, 29, 39 | 0 | 2 | 6 | 2 |
| 3 | A1 | 8 | 1 | 4, 9, 14, 19, | 0 | 2 | 6 | 2 |
| | | | | 24, 29, 34, | | | | |
| | | | | 39 | | | | |
| 4 | A1 | 8 | 1 | 3, 7, 11, 15, | 0 | 1 | 6 | 2 |
| | | | | 19, 23, 27, | | | | |
| | | | | 31, | | | | |
| | | | | 35, 39 | | | | |
| 5 | A1 | 4 | 1 | 4, 9, 14, 19, | 0 | 1 | 6 | 2 |
| | | | | 24, 29, 34, | | | | |
| | | | | 39 | | | | |
| 6 | A1 | 4 | 1 | 4, 9, 14, 19, | 0 | 2 | 6 | 2 |
| | | | | 24, 29, 34, | | | | |
| | | | | 39 | | | | |
| 7 | A1 | 4 | 1 | 3, 7, 11, 15, | 0 | 1 | 6 | 2 |
| | | | | 19, 23, 27, 31, | | | | |
| | | | | 35, 39 | | | | |
| 8 | A1 | 2 | 1 | 7, 15, 23, 31, | 0 | 2 | 6 | 2 |
| | | | | 39 | | | | |
| 9 | A1 | 2 | 1 | 4, 9, 14, 19, | 0 | 1 | 6 | 2 |
| | | | | 24, 29, 34, | | | | |
| | | | | 39 | | | | |
| 10 | A1 | 2 | 1 | 4, 9, 14, 19, | 0 | 2 | 6 | 2 |
| | | | | 24, 29, 34, 39 | | | | |
| 11 | A1 | 2 | 1 | 3, 7, 11, 15, | 0 | 1 | 6 | 2 |
| | | | | 19, 23, 27, 31, | | | | |
| | | | | 35, 39 | | | | |
| 12 | A1 | 1 | 0 | 19, 39 | 7 | 1 | 3 | 2 |
| 13 | A1 | 1 | 0 | 3, 5, 7 | 0 | 1 | 6 | 2 |
| 14 | A1 | 1 | 0 | 24, 29, 34, 39 | 7 | 1 | 3 | 2 |
| 15 | A1 | 1 | 0 | 9, 19, 29, 39 | 7 | 2 | 3 | 2 |
| 16 | A1 | 1 | 0 | 17, 19, 37, 39 | 0 | 1 | 6 | 2 |
| 17 | A1 | 1 | 0 | 9, 19, 29, 39 | 0 | 2 | 6 | 2 |
| 18 | A1 | 1 | 0 | 4, 9, 14, 19, | 0 | 1 | 6 | 2 |
| | | | | 24, 29, 34, 39 | | | | |
| 19 | A1 | 1 | 0 | 4, 9, 14, 19, | 7 | 1 | 3 | 2 |
| | | | | 24, 29, 34, 39 | | | | |
| 20 | A1 | 1 | 0 | 3, 5, 7, 9, | 7 | 1 | 3 | 2 |
| | | | | 11, 13 | | | | |
| 21 | A1 | 1 | 0 | 23, 27, 31, 35, | 7 | 1 | 3 | 2 |
| | | | | 39 | | | | |
| 22 | A1 | 1 | 0 | 7, 15, 23, 31, | 0 | 1 | 6 | 2 |
| | | | | 39 | | | | |
| 23 | A1 | 1 | 0 | 23, 27, 31, 35, | 0 | 1 | 6 | 2 |
| | | | | 39 | | | | |
| 24 | A1 | 1 | 0 | 13, 14, 15, 29, | 7 | 2 | 3 | 2 |
| | | | | 30, 31, 37, 38, | | | | |
| | | | | 39 | | | | |
| 25 | A1 | 1 | 0 | 3, 7, 11, 15, | 7 | 1 | 3 | 2 |
| | | | | 19, 23, 27, 31, | | | | |
| | | | | 35, 39 | | | | |
| 26 | A1 | 1 | 0 | 3, 7, 11, 15, | 0 | 1 | 6 | 2 |
| | | | | 19, 23, 27, 31, | | | | |
| | | | | 35, 39 | | | | |
| 27 | A1 | 1 | 0 | 1, 3, 5, 7, | 0 | 1 | 6 | 2 |
| | | | | . . . , 37, 39 | | | | |
| 28 | A1 | 1 | 0 | 0, 1, 2, | 7 | 1 | 3 | 2 |
| | | | | . . . , 39 | | | | |
| 29 | A2 | 16 | 1 | 4, 9, 14, 19, | 0 | 2 | 3 | 4 |
| | | | | 24, 29, 34, 39 | | | | |
| 30 | A2 | 16 | 1 | 3, 7, 11, 15, | 0 | 1 | 3 | 4 |
| | | | | 19, 23, 27, 31, | | | | |
| | | | | 35, 39 | | | | |
| 31 | A2 | 8 | 1 | 4, 9, 14, 19, | 0 | 2 | 3 | 4 |
| | | | | 24, 29, 34, 39 | | | | |
| 32 | A2 | 8 | 1 | 3, 7, 11, 15, | 0 | 1 | 3 | 4 |
| | | | | 19, 23, 27, 31, | | | | |
| | | | | 35, 39 | | | | |
| 33 | A2 | 8 | 1, 2 | 9, 19, 29, 39 | 0 | 2 | 3 | 4 |
| 34 | A2 | 4 | 1 | 4, 9, 14, 19, | 0 | 1 | 3 | 4 |
| | | | | 24, 29, 34, 39 | | | | |
| 35 | A2 | 4 | 1 | 4, 9, 14, 19, | 0 | 2 | 3 | 4 |
| | | | | 24, 29, 34, 39 | | | | |
| 36 | A2 | 4 | 1 | 3, 7, 11, 15, | 0 | 1 | 3 | 4 |
| | | | | 19, 23, 27, 31, | | | | |
| | | | | 35, 39 | | | | |
| 37 | A2 | 2 | 1 | 7, 15, 23, 31, | 0 | 2 | 3 | 4 |
| | | | | 39 | | | | |
| 38 | A2 | 2 | 1 | 4, 9, 14, 19, | 0 | 1 | 3 | 4 |
| | | | | 24, 29, 34, 39 | | | | |
| 39 | A2 | 2 | 1 | 4, 9, 14, 19, | 0 | 2 | 3 | 4 |
| | | | | 24, 29, 34, 39 | | | | |
| 40 | A2 | 2 | 1 | 3, 7, 11, 15, | 0 | 1 | 3 | 4 |
| | | | | 19, 23, 27, 31, | | | | |
| | | | | 35, 39 | | | | |
| 41 | A2 | 1 | 0 | 19, 39 | 5 | 1 | 2 | 4 |
| 42 | A2 | 1 | 0 | 3, 5, 7 | 0 | 1 | 3 | 4 |
| 43 | A2 | 1 | 0 | 24, 29, 34, 39 | 5 | 1 | 2 | 4 |
| 44 | A2 | 1 | 0 | 9, 19, 29, 39 | 5 | 2 | 2 | 4 |
| 45 | A2 | 1 | 0 | 17, 19, 37, 39 | 0 | 1 | 3 | 4 |
| 46 | A2 | 1 | 0 | 9, 19, 29, 39 | 0 | 2 | 3 | 4 |
| 47 | A2 | 1 | 0 | 7, 15, 23, 31, | 0 | 1 | 3 | 4 |
| | | | | 39 | | | | |
| 48 | A2 | 1 | 0 | 23, 27, 31, 35, | 5 | 1 | 2 | 4 |
| | | | | 39 | | | | |
| 49 | A2 | 1 | 0 | 23, 27, 31, 35, | 0 | 1 | 3 | 4 |
| | | | | 39 | | | | |
| 50 | A2 | 1 | 0 | 3, 5, 7, 9, | 5 | 1 | 2 | 4 |
| | | | | 11, 13 | | | | |
| 51 | A2 | 1 | 0 | 3, 5, 7, 9, | 0 | 1 | 3 | 4 |
| | | | | 11, 13 | | | | |
| 52 | A2 | 1 | 0 | 4, 9, 14, 19, | 5 | 1 | 2 | 4 |
| | | | | 24, 29, 34, 39 | | | | |
| 53 | A2 | 1 | 0 | 4, 9, 14, 19, | 0 | 1 | 3 | 4 |
| | | | | 24, 29, 34, 39 | | | | |
| 54 | A2 | 1 | 0 | 13, 14, 15, 29, | 5 | 2 | 2 | 4 |
| | | | | 30, 31, 37, 38, | | | | |
| | | | | 39 | | | | |
| 55 | A2 | 1 | 0 | 3, 7, 11, 15, | 5 | 1 | 2 | 4 |
| | | | | 19, 23, 27, 31, | | | | |
| | | | | 35, 39 | | | | |
| 56 | A2 | 1 | 0 | 3, 7, 11, 15, | 0 | 1 | 3 | 4 |
| | | | | 19, 23, 27, 31, | | | | |
| | | | | 35, 39 | | | | |
| 57 | A2 | 1 | 0 | 1, 3, 5, 7, | 0 | 1 | 3 | 4 |
| | | | | . . . , 37, 39 | | | | |
| 58 | A2 | 1 | 0 | 0, 1, 2, | 5 | 1 | 2 | 4 |
| | | | | . . . , 39 | | | | |
| 59 | A3 | 16 | 1 | 4, 9, 14, 19, | 0 | 2 | 2 | 6 |
| | | | | 24, 29, 34, 39 | | | | |
| 60 | A3 | 16 | 1 | 3, 7, 11, 15, | 0 | 1 | 2 | 6 |
| | | | | 19, 23, 27, 31, | | | | |
| | | | | 35, 39 | | | | |
| 61 | A3 | 8 | 1 | 4, 9, 14, 19, | 0 | 2 | 2 | 6 |
| | | | | 24, 29, 34, 39 | | | | |
| 62 | A3 | 8 | 1 | 3, 7, 11, 15, | 0 | 1 | 2 | 6 |
| | | | | 19, 23, 27, 31, | | | | |
| | | | | 35, 39 | | | | |
| 63 | A3 | 8 | 1, 2 | 9, 19, 29, 39 | 0 | 2 | 2 | 6 |
| 64 | A3 | 4 | 1 | 4, 9, 14, 19, | 0 | 1 | 2 | 6 |
| | | | | 24, 29, 34, 39 | | | | |
| 65 | A3 | 4 | 1 | 4, 9, 14, 19, | 0 | 2 | 2 | 6 |
| | | | | 24, 29, 34, 39 | | | | |
| 66 | A3 | 4 | 1 | 3, 7, 11, 15, 19, | 0 | 1 | 2 | 6 |
| | | | | 23, 27, 31, 35, 39 | | | | |
| 67 | A3 | 2 | 1 | 4, 9, 14, 19, | 0 | 1 | 2 | 6 |
| | | | | 24, 29, 34, 39 | | | | |
| 68 | A3 | 2 | 1 | 4, 9, 14, 19, | 0 | 2 | 2 | 6 |
| | | | | 24, 29, 34, 39 | | | | |
| 69 | A3 | 2 | 1 | 3, 7, 11, 15, 19, | 0 | 1 | 2 | 6 |
| | | | | 23, 27, 31, 35, 39 | | | | |
| 70 | A3 | 1 | 0 | 19, 39 | 7 | 1 | 1 | 6 |
| 71 | A3 | 1 | 0 | 3, 5, 7 | 0 | 1 | 2 | 6 |
| 72 | A3 | 1 | 0 | 9, 11, 13 | 2 | 1 | 2 | 6 |
| 73 | A3 | 1 | 0 | 24, 29, 34, 39 | 7 | 1 | 1 | 6 |
| 74 | A3 | 1 | 0 | 9, 19, 29, 39 | 7 | 2 | 1 | 6 |
| 75 | A3 | 1 | 0 | 17, 19, 37, 39 | 0 | 1 | 2 | 6 |
| 76 | A3 | 1 | 0 | 9, 19, 29, 39 | 0 | 2 | 2 | 6 |
| 77 | A3 | 1 | 0 | 7, 15, 23, 31, 39 | 0 | 1 | 2 | 6 |
| 78 | A3 | 1 | 0 | 23, 27, 31, 35, 39 | 7 | 1 | 1 | 6 |
| 79 | A3 | 1 | 0 | 23, 27, 31, 35, 39 | 0 | 1 | 2 | 6 |
| 80 | A3 | 1 | 0 | 3, 5, 7, 9, 11, 13 | 0 | 1 | 2 | 6 |
| 81 | A3 | 1 | 0 | 3, 5, 7, 9, 11, 13 | 7 | 1 | 1 | 6 |
| 82 | A3 | 1 | 0 | 4, 9, 14, 19, | 0 | 1 | 2 | 6 |
| | | | | 24, 29, 34, 39 | | | | |
| 83 | A3 | 1 | 0 | 4, 9, 14, 19, | 7 | 1 | 1 | 6 |
| | | | | 24, 29, 34, 39 | | | | |
| 84 | A3 | 1 | 0 | 13, 14, 15, 29, | 7 | 2 | 1 | 6 |
| | | | | 30, 31, 37, 38, 39 | | | | |
| 85 | A3 | 1 | 0 | 3, 7, 11, 15, 19, | 7 | 1 | 1 | 6 |
| | | | | 23, 27, 31, 35, 39 | | | | |
| 86 | A3 | 1 | 0 | 3, 7, 11, 15, 19, | 0 | 1 | 2 | 6 |
| | | | | 23, 27, 31, 35, 39 | | | | |
| 87 | A3 | 1 | 0 | 1, 3, 5, 7, | 0 | 1 | 2 | 6 |
| | | | | . . . , 37, 39 | | | | |
| 88 | A3 | 1 | 0 | 0, 1, 2, . . . , 39 | 7 | 1 | 1 | 6 |
| 89 | B1 | 16 | 1 | 4, 9, 14, 19, | 2 | 2 | 6 | 2 |
| | | | | 24, 29, 34, 39 | | | | |
| 90 | B1 | 8 | 1 | 4, 9, 14, 19, | 2 | 2 | 6 | 2 |
| | | | | 24, 29, 34, 39 | | | | |
| 91 | B1 | 8 | 1, 2 | 9, 19, 29, 39 | 2 | 2 | 6 | 2 |
| 92 | B1 | 4 | 1 | 4, 9, 14, 19, | 2 | 2 | 6 | 2 |
| | | | | 24, 29, 34, 39 | | | | |
| 93 | B1 | 2 | 1 | 4, 9, 14, 19, | 2 | 2 | 6 | 2 |
| | | | | 24, 29, 34, 39 | | | | |
| 94 | B1 | 2 | 1 | 3, 7, 11, 15, 19, | 2 | 1 | 6 | 1 |
| | | | | 23, 27, 31, 35, 39 | | | | |
| 95 | B1 | 1 | 0 | 19, 39 | 8 | 1 | 3 | 2 |
| 96 | B1 | 1 | 0 | 3, 5, 7 | 2 | 1 | 6 | 2 |
| 97 | B1 | 1 | 0 | 24, 29, 34, 39 | 8 | 1 | 3 | 2 |
| 98 | B1 | 1 | 0 | 9, 19, 29, 39 | 8 | 2 | 3 | 2 |
| 99 | B1 | 1 | 0 | 17, 19, 37, 39 | 2 | 1 | 6 | 2 |
| 100 | B1 | 1 | 0 | 9, 19, 29, 39 | 2 | 2 | 6 | 2 |
| 101 | B1 | 1 | 0 | 7, 15, 23, 31, 39 | 2 | 1 | 6 | 2 |
| 102 | B1 | 1 | 0 | 23, 27, 31, 35, 39 | 8 | 1 | 3 | 2 |
| 103 | B1 | 1 | 0 | 23, 27, 31, 35, 39 | 2 | 1 | 6 | 2 |
| 104 | B1 | 1 | 0 | 3, 5, 7, 9, 11, 13 | 8 | 1 | 3 | 2 |
| 105 | B1 | 1 | 0 | 4, 9, 14, 19, | 8 | 1 | 3 | 2 |
| | | | | 24, 29, 34, 39 | | | | |
| 106 | B1 | 1 | 0 | 4, 9, 14, 19, | 2 | 1 | 6 | 2 |
| | | | | 24, 29, 34, 39 | | | | |
| 107 | B1 | 1 | 0 | 3, 7, 11, 15, 19, | 8 | 1 | 3 | 2 |
| | | | | 23, 27, 31, 35, 39 | | | | |
| 108 | B1 | 1 | 0 | 13, 14, 15, 29, | 8 | 2 | 3 | 2 |
| | | | | 30, 31, 37, 38, 39 | | | | |
| 109 | B1 | 1 | 0 | 3, 7, 11, 15, 19, | 2 | 1 | 6 | 2 |
| | | | | 23, 27, 31, 35, 39 | | | | |
| 110 | B1 | 1 | 0 | 1, 3, 5, 7, . . . , | 2 | 1 | 6 | 2 |
| | | | | 37, 39 | | | | |
| 111 | B1 | 1 | 0 | 0, 1, 2, . . . , 39 | 8 | 1 | 3 | 2 |
| 112 | B4 | 16 | 1, 2 | 4, 9, 14, 19, | 0 | 2 | 1 | 12 |
| | | | | 24, 29, 34, 39 | | | | |
| 113 | B4 | 16 | 1, 2 | 3, 7, 11, 15, 19, | 0 | 1 | 1 | 12 |
| | | | | 23, 27, 31, 35, 39 | | | | |
| 114 | B4 | 8 | 1, 2 | 4, 9, 14, 19, | 0 | 2 | 1 | 12 |
| | | | | 24, 29, 34, 39 | | | | |
| 115 | B4 | 8 | 1, 2 | 3, 7, 11, 15, 19, | 0 | 1 | 1 | 12 |
| | | | | 23, 27, 31, 35, 39 | | | | |
| 116 | B4 | 8 | 1, 2 | 9, 19, 29, 39 | 0 | 2 | 1 | 12 |
| 117 | B4 | 4 | 1 | 4, 9, 14, 19, | 0 | 1 | 1 | 12 |
| | | | | 24, 29, 34, 39 | | | | |
| 118 | B4 | 4 | 1 | 4, 9, 14, 19, | 0 | 2 | 1 | 12 |
| | | | | 24, 29, 34, 39 | | | | |
| 119 | B4 | 4 | 1, 2 | 3, 7, 11, 15, 19, | 0 | 1 | 1 | 12 |
| | | | | 23, 27, 31, 35, 39 | | | | |
| 120 | B4 | 2 | 1 | 7, 15, 23, 31, 39 | 2 | 2 | 1 | 12 |
| 121 | B4 | 2 | 1 | 4, 9, 14, 19, | 0 | 1 | 1 | 12 |
| | | | | 24, 29, 34, 39 | | | | |
| 122 | B4 | 2 | 1 | 4, 9, 14, 19, | 0 | 2 | 1 | 12 |
| | | | | 24, 29, 34, 39 | | | | |
| 123 | B4 | 2 | 1 | 3, 7, 11, 15, 19, | 0 | 1 | 1 | 12 |
| | | | | 23, 27, 31, 35, 39 | | | | |
| 124 | B4 | 1 | 0 | 19, 39 | 2 | 2 | 1 | 12 |
| 125 | B4 | 1 | 0 | 17, 19, 37, 39 | 0 | 1 | 1 | 12 |
| 126 | B4 | 1 | 0 | 24, 29, 34, 39 | 2 | 1 | 1 | 12 |
| 127 | B4 | 1 | 0 | 9, 19, 29, 39 | 2 | 2 | 1 | 12 |
| 128 | B4 | 1 | 0 | 9, 19, 29, 39 | 0 | 2 | 1 | 12 |
| 129 | B4 | 1 | 0 | 7, 15, 23, 31, 39 | 0 | 1 | 1 | 12 |
| 130 | B4 | 1 | 0 | 7, 15, 23, 31, 39 | 0 | 2 | 1 | 12 |
| 131 | B4 | 1 | 0 | 23, 27, 31, 35, 39 | 0 | 1 | 1 | 12 |
| 132 | B4 | 1 | 0 | 23, 27, 31, 35, 39 | 2 | 2 | 1 | 12 |
| 133 | B4 | 1 | 0 | 9, 11, 13, 15, 17, 19 | 0 | 1 | 1 | 12 |
| 134 | B4 | 1 | 0 | 3, 5, 7, 9, 11, 13 | 2 | 1 | 1 | 12 |
| 135 | B4 | 1 | 0 | 4, 9, 14, 19, | 0 | 1 | 1 | 12 |
| | | | | 24, 29, 34, 39 | | | | |
| 136 | B4 | 1 | 0 | 4, 9, 14, 19, | 2 | 2 | 1 | 12 |
| | | | | 24, 29, 34, 39 | | | | |
| 137 | B4 | 1 | 0 | 13, 14, 15, 29, | 2 | 2 | 1 | 12 |
| | | | | 30, 31, 37, 38, 39 | | | | |
| 138 | B4 | 1 | 0 | 3, 7, 11, 15, 19, | 0 | 1 | 1 | 12 |
| | | | | 23, 27, 31, 35, 39 | | | | |
| 139 | B4 | 1 | 0 | 3, 7, 11, 15, 19, | 2 | 1 | 1 | 12 |
| | | | | 23, 27, 31, 35, 39 | | | | |
| 140 | B4 | 1 | 0 | 3, 5, 7, . . . , | 2 | 1 | 1 | 12 |
| | | | | 23, 25 | | | | |
| 141 | B4 | 1 | 0 | 3, 5, 7, . . . , | 0 | 2 | 1 | 12 |
| | | | | 23, 25 | | | | |
| 142 | B4 | 1 | 0 | 1, 3, 5, 7, . . . , | 0 | 1 | 1 | 12 |
| | | | | 37, 39 | | | | |
| 143 | B4 | 1 | 0 | 0, 1, 2, . . . , | 2 | 1 | 1 | 12 |
| | | | | 39 | | | | |
| 144 | C0 | 16 | 1 | 4, 9, 14, 19, | 0 | 2 | 7 | 2 |
| | | | | 24, 29, 34, 39 | | | | |
| 145 | C0 | 16 | 1 | 3, 7, 11, 15, 19, | 0 | 1 | 7 | 2 |
| | | | | 23, 27, 31, 35, 39 | | | | |
| 146 | C0 | 8 | 1 | 4, 9, 14, 19, 24, | 0 | 1 | 7 | 2 |
| | | | | 29, 34, 39 | | | | |
| 147 | C0 | 8 | 1 | 3, 7, 11, 15, 19, | 0 | 1 | 7 | 2 |
| | | | | 23, 27, 31, 35, 39 | | | | |
| 148 | C0 | 8 | 1, 2 | 9, 19, 29, 39 | 0 | 2 | 7 | 2 |
| 149 | C0 | 4 | 1 | 4, 9, 14, 19, | 0 | 1 | 7 | 2 |
| | | | | 24, 29, 34, 39 | | | | |
| 150 | C0 | 4 | 1 | 4, 9, 14, 19, | 0 | 2 | 7 | 2 |
| | | | | 24, 29, 34, 39 | | | | |
| 151 | C0 | 4 | 1 | 3, 7, 11, 15, 19, | 0 | 1 | 7 | 2 |
| | | | | 23, 27, 31, 35, 39 | | | | |
| 152 | C0 | 2 | 1 | 7, 15, 23, 31, 39 | 0 | 2 | 7 | 2 |
| 153 | C0 | 2 | 1 | 4, 9, 14, 19, | 0 | 1 | 7 | 2 |
| | | | | 24, 29, 34, 39 | | | | |
| 154 | C0 | 2 | 1 | 4, 9, 14, 19, | 0 | 2 | 7 | 2 |
| | | | | 24, 29, 34, 39 | | | | |
| 155 | C0 | 2 | 1 | 3, 7, 11, 15, 19, | 0 | 1 | 7 | 2 |
| | | | | 23, 27, 31, 35, 39 | | | | |
| 156 | C0 | 1 | 0 | 19, 39 | 8 | 1 | 3 | 2 |
| 157 | C0 | 1 | 0 | 3, 5, 7 | 0 | 1 | 7 | 2 |
| 158 | C0 | 1 | 0 | 24, 29, 34, 39 | 8 | 1 | 3 | 2 |
| 159 | C0 | 1 | 0 | 9, 19, 29, 39 | 8 | 2 | 3 | 2 |
| 160 | C0 | 1 | 0 | 17, 19, 37, 39 | 0 | 1 | 7 | 2 |
| 161 | C0 | 1 | 0 | 9, 19, 29, 39 | 0 | 2 | 7 | 2 |
| 162 | C0 | 1 | 0 | 23, 27, 31, 35, 39 | 8 | 1 | 3 | 2 |
| 163 | C0 | 1 | 0 | 7, 15, 23, 31, 39 | 0 | 1 | 7 | 2 |
| 164 | C0 | 1 | 0 | 23, 27, 31, 35, 39 | 0 | 1 | 7 | 2 |
| 165 | C0 | 1 | 0 | 3, 5, 7, 9, 11, 13 | 8 | 1 | 3 | 2 |
| 166 | C0 | 1 | 0 | 4, 9, 14, 19, | 8 | 1 | 3 | 2 |
| | | | | 24, 29, 34, 39 | | | | |
| 167 | C0 | 1 | 0 | 4, 9, 14, 19, | 0 | 1 | 7 | 2 |
| | | | | 24, 29, 34, 39 | | | | |
| 168 | C0 | 1 | 0 | 13, 14, 15, 29, | 8 | 2 | 3 | 2 |
| | | | | 30, 31, 37, 38, 39 | | | | |
| 169 | C0 | 1 | 0 | 3, 7, 11, 15, 19, | 8 | 1 | 3 | 2 |
| | | | | 23, 27, 31, 35, 39 | | | | |
| 170 | C0 | 1 | 0 | 3, 7, 11, 15, 19, | 0 | 1 | 7 | 2 |
| | | | | 23, 27, 31, 35, 39 | | | | |
| 171 | C0 | 1 | 0 | 1, 3, 5, 7, | 0 | 1 | 7 | 2 |
| | | | | . . . , 37, 39 | | | | |
| 172 | C0 | 1 | 0 | 0, 1, 2, | 8 | 1 | 3 | 2 |
| | | | | . . . , 39 | | | | |
| 173 | C2 | 16 | 1 | 4, 9, 14, 19, | 0 | 2 | 2 | 6 |
| | | | | 24, 29, 34, 39 | | | | |
| 174 | C2 | 16 | 1 | 3, 7, 11, 15, 19, | 0 | 1 | 2 | 6 |
| | | | | 23, 27, 31, 35, 39 | | | | |
| 175 | C2 | 8 | 1 | 4, 9, 14, 19, | 0 | 2 | 2 | 6 |
| | | | | 24, 29, 34, 39 | | | | |
| 176 | C2 | 8 | 1 | 3, 7, 11, 15, 19, | 0 | 1 | 2 | 6 |
| | | | | 23, 27, 31, 35, 39 | | | | |
| 177 | C2 | 8 | 1, 2 | 9, 19, 29, 39 | 0 | 2 | 2 | 6 |
| 178 | C2 | 4 | 1 | 4, 9, 14, 19, | 0 | 1 | 2 | 6 |
| | | | | 24, 29, 34, 39 | | | | |
| 179 | C2 | 4 | 1 | 4, 9, 14, 19, | 0 | 2 | 2 | 6 |
| | | | | 24, 29, 34, 39 | | | | |
| 180 | C2 | 4 | 1 | 3, 7, 11, 15, 19, | 0 | 1 | 2 | 6 |
| | | | | 23, 27, 31, 35, 39 | | | | |
| 181 | C2 | 2 | 1 | 7, 15, 23, 31, 39 | 2 | 2 | 2 | 6 |
| 182 | C2 | 2 | 1 | 4, 9, 14, 19, | 0 | 1 | 2 | 6 |
| | | | | 24, 29, 34, 39 | | | | |
| 183 | C2 | 2 | 1 | 4, 9, 14, 19, | 0 | 2 | 2 | 6 |
| | | | | 24, 29, 34, 39 | | | | |
| 184 | C2 | 2 | 1 | 3, 7, 11, 15, 19, | 0 | 1 | 2 | 6 |
| | | | | 23, 27, 31, 35, 39 | | | | |
| 185 | C2 | 1 | 0 | 19, 39 | 2 | 1 | 2 | 6 |
| 186 | C2 | 1 | 0 | 3, 5, 7 | 0 | 1 | 2 | 6 |
| 187 | C2 | 1 | 0 | 24, 29, 34, 39 | 7 | 1 | 1 | 6 |
| 188 | C2 | 1 | 0 | 9, 19, 29, 39 | 7 | 2 | 1 | 6 |
| 189 | C2 | 1 | 0 | 17, 19, 37, 39 | 0 | 1 | 2 | 6 |
| 190 | C2 | 1 | 0 | 9, 19, 29, 39 | 2 | 2 | 2 | 6 |
| 191 | C2 | 1 | 0 | 7, 15, 23, | 2 | 1 | 2 | 6 |
| | | | | 31, 39 | | | | |
| 192 | C2 | 1 | 0 | 3, 5, 7, 9, 11, 13 | 7 | 1 | 1 | 6 |
| 193 | C2 | 1 | 0 | 23, 27, 31, 35, 39 | 7 | 2 | 1 | 6 |
| 194 | C2 | 1 | 0 | 23, 27, 31, 35, 39 | 0 | 1 | 2 | 6 |
| 195 | C2 | 1 | 0 | 4, 9, 14, 19, 24, | 7 | 2 | 1 | 6 |
| | | | | 29, 34, 39 | | | | |
| 196 | C2 | 1 | 0 | 4, 9, 14, 19, | 2 | 1 | 2 | 6 |
| | | | | 24, 29, 34, 39 | | | | |
| 197 | C2 | 1 | 0 | 13, 14, 15, 29, | 7 | 2 | 1 | 6 |
| | | | | 30, 31, 37, 38, 39 | | | | |
| 198 | C2 | 1 | 0 | 3, 7, 11, 15, 19, | 7 | 1 | 1 | 6 |
| | | | | 23, 27, 31, 35, 39 | | | | |
| 199 | C2 | 1 | 0 | 3, 7, 11, 15, 19, | 0 | 1 | 2 | 6 |
| | | | | 23, 27, 31, 35, 39 | | | | |
| 200 | C2 | 1 | 0 | 1, 3, 5, 7, | 0 | 1 | 2 | 6 |
| | | | | . . . , 37, 39 | | | | |
| 201 | C2 | 1 | 0 | 0, 1, 2, . . . , 39 | 7 | 1 | 1 | 6 |
| 202 | A1/B1 | 16 | 1 | 4, 9, 14, 19, 24, | 2 | 1 | 6 | 2 |
| | | | | 29, 34, 39 | | | | |
| 203 | A1/B1 | 16 | 1 | 3, 7, 11, 15, 19, | 2 | 1 | 6 | 2 |
| | | | | 23, 27, 31, 35, 39 | | | | |
| 204 | A1/B1 | 8 | 1 | 4, 9, 14, 19, | 2 | 1 | 6 | 2 |
| | | | | 24, 29, 34, 39 | | | | |
| 205 | A1/B1 | 8 | 1 | 3, 7, 11, 15, 19, | 2 | 1 | 6 | 2 |
| | | | | 23, 27, 31, 35, 39 | | | | |
| 206 | A1/B1 | 4 | 1 | 4, 9, 14, 19, | 2 | 1 | 6 | 2 |
| | | | | 24, 29, 34, 39 | | | | |
| 207 | A1/B1 | 4 | 1 | 3, 7, 11, 15, 19, | 2 | 1 | 6 | 2 |
| | | | | 23, 27, 31, 35, 39 | | | | |
| 208 | A1/B1 | 2 | 1 | 4, 9, 14, 19, 24, 29, | 2 | 1 | 6 | 2 |
| | | | | 34, 39 | | | | |
| 209 | A1/B1 | 1 | 0 | 19, 39 | 8 | 1 | 3 | 2 |
| 210 | A1/B1 | 1 | 0 | 9, 19, 29, 39 | 8 | 1 | 3 | 2 |
| 211 | A1/B1 | 1 | 0 | 17, 19, 37, 39 | 2 | 1 | 6 | 2 |
| 212 | A1/B1 | 1 | 0 | 9, 19, 29, 39 | 2 | 2 | 6 | 2 |
| 213 | A1/B1 | 1 | 0 | 23, 27, 31, 35, 39 | 8 | 1 | 3 | 2 |
| 214 | A1/B1 | 1 | 0 | 7, 15, 23, 31, 39 | 2 | 1 | 6 | 2 |
| 215 | A1/B1 | 1 | 0 | 23, 27, 31, 35, 39 | 2 | 1 | 6 | 2 |
| 216 | A1/B1 | 1 | 0 | 4, 9, 14, 19, | 8 | 1 | 3 | 2 |
| | | | | 24, 29, 34, 39 | | | | |
| 217 | A1/B1 | 1 | 0 | 4, 9, 14, 19, | 2 | 1 | 6 | 2 |
| | | | | 24, 29, 34, 39 | | | | |
| 218 | A1/B1 | 1 | 0 | 3, 7, 11, 15, 19, | 2 | 1 | 6 | 2 |
| | | | | 23, 27, 31, 35, 39 | | | | |
| 219 | A1/B1 | 1 | 0 | 1, 3, 5, 7, | 2 | 1 | 6 | 2 |
| | | | | . . . , 37, 39 | | | | |
| 220 | A2/B2 | 16 | 1 | 4, 9, 14, 19, | 2 | 1 | 3 | 4 |
| | | | | 24, 29, 34, 39 | | | | |
| 221 | A2/B2 | 16 | 1 | 3, 7, 11, 15, 19, | 2 | 1 | 3 | 4 |
| | | | | 23, 27, 31, 35, 39 | | | | |
| 222 | A2/B2 | 8 | 1 | 4, 9, 14, 19, | 2 | 1 | 3 | 4 |
| | | | | 24, 29, 34, 39 | | | | |
| 223 | A2/B2 | 8 | 1 | 3, 7, 11, 15, 19, | 2 | 1 | 3 | 4 |
| | | | | 23, 27, 31, 35, 39 | | | | |
| 224 | A2/B2 | 4 | 1 | 4, 9, 14, 19, | 2 | 1 | 3 | 4 |
| | | | | 24, 29, 34, 39 | | | | |
| 225 | A2/B2 | 4 | 1 | 3, 7, 11, 15, 19, | 2 | 1 | 3 | 4 |
| | | | | 23, 27, 31, 35, 39 | | | | |
| 226 | A2/B2 | 2 | 1 | 4, 9, 14, 19, | 2 | 1 | 3 | 4 |
| | | | | 24, 29, 34, 39 | | | | |
| 227 | A2/B2 | 1 | 0 | 19, 39 | 6 | 1 | 2 | 4 |
| 228 | A2/B2 | 1 | 0 | 9, 19, 29, 39 | 6 | 1 | 2 | 4 |
| 229 | A2/B2 | 1 | 0 | 17, 19, 37, 39 | 2 | 1 | 3 | 4 |
| 230 | A2/B2 | 1 | 0 | 9, 19, 29, 39 | 2 | 2 | 3 | 4 |
| 231 | A2/B2 | 1 | 0 | 23, 27, 31, 35, 39 | 6 | 1 | 2 | 4 |
| 232 | A2/B2 | 1 | 0 | 7, 15, 23, 31, 39 | 2 | 1 | 3 | 4 |
| 233 | A2/B2 | 1 | 0 | 23, 27, 31, 35, 39 | 2 | 1 | 3 | 4 |
| 234 | A2/B2 | 1 | 0 | 4, 9, 14, 19, | 6 | 1 | 2 | 4 |
| | | | | 24, 29, 34, 39 | | | | |
| 235 | A2/B2 | 1 | 0 | 4, 9, 14, 19, | 2 | 1 | 3 | 4 |
| | | | | 24, 29, 34, 39 | | | | |
| 236 | A2/B2 | 1 | 0 | 3, 7, 11, 15, 19, | 2 | 1 | 3 | 4 |
| | | | | 23, 27, 31, 35, 39 | | | | |
| 237 | A2/B2 | 1 | 0 | 1, 3, 5, 7, . . . , | 2 | 1 | 3 | 4 |
| | | | | 37, 39 | | | | |
| 238 | A3/B3 | 16 | 1 | 4, 9, 14, 19, | 2 | 1 | 2 | 6 |
| | | | | 24, 29, 34, 39 | | | | |
| 239 | A3/B3 | 16 | 1 | 3, 7, 11, 15, 19, | 2 | 1 | 2 | 6 |
| | | | | 23, 27, 31, 35, 39 | | | | |
| 240 | A3/B3 | 8 | 1 | 4, 9, 14, 19, | 2 | 1 | 2 | 6 |
| | | | | 24, 29, 34, 39 | | | | |
| 241 | A3/B3 | 8 | 1 | 3, 7, 11, 15, 19, | 2 | 1 | 2 | 6 |
| | | | | 23, 27, 31, 35, 39 | | | | |
| 242 | A3/B3 | 4 | 1 | 4, 9, 14, 19, | 2 | 1 | 2 | 6 |
| | | | | 24, 29, 34, 39 | | | | |
| 243 | A3/B3 | 4 | 1 | 3, 7, 11, 15, 19, | 2 | 1 | 2 | 6 |
| | | | | 23, 27, 31, 35, 39 | | | | |
| 244 | A3/B3 | 2 | 1 | 4, 9, 14, 19, | 2 | 1 | 2 | 6 |
| | | | | 24, 29, 34, 39 | | | | |
| 245 | A3/B3 | 1 | 0 | 19, 39 | 2 | 1 | 2 | 6 |
| 246 | A3/B3 | 1 | 0 | 9, 19, 29, 39 | 2 | 1 | 2 | 6 |
| 247 | A3/B3 | 1 | 0 | 17, 19, 37, 39 | 2 | 1 | 2 | 6 |
| 248 | A3/B3 | 1 | 0 | 9, 19, 29, 39 | 2 | 2 | 2 | 6 |
| 249 | A3/B3 | 1 | 0 | 7, 15, 23, 31, 39 | 2 | 1 | 2 | 6 |
| 250 | A3/B3 | 1 | 0 | 23, 27, 31, 35, 39 | 2 | 1 | 2 | 6 |
| 251 | A3/B3 | 1 | 0 | 23, 27, 31, 35, 39 | 2 | 2 | 2 | 6 |
| 252 | A3/B3 | 1 | 0 | 4, 9, 14, 19, | 2 | 1 | 2 | 6 |
| | | | | 24, 29, 34, 39 | | | | |
| 253 | A3/B3 | 1 | 0 | 4, 9, 14, 19, | 2 | 2 | 2 | 6 |
| | | | | 24, 29, 34, 39 | | | | |
| 254 | A3/B3 | 1 | 0 | 3, 7, 11, 15, 19, | 2 | 1 | 2 | 6 |
| | | | | 23, 27, 31, 35, 39 | | | | |
| 255 | A3/B3 | 1 | 0 | 1, 3, 5, 7, | 2 | 1 | 2 | 6 |
| | | | | . . . , 37, 39 | | | | |

For example, in embodiments described below, the ROs may be ROs based on one of Tables 2 to 4 above.

The contents described above can be applied by being combined with methods according to the present disclosure described below, or can be supplemented to clarify technical features of methods described in the present disclosure.

In addition, methods related to configuration of a PRACH transmission occasion described below are related to uplink transmission and can be equally applied to an uplink signal transmission method in the NR system (licensed band) or U-Band system (unlicensed band) described above. The technical ideas described in the present disclosure can be modified or replaced to suit terms, expressions, structures, etc. defined in each system so that they can be implemented in the corresponding systems.

For example, the uplink transmission through the methods related to configuration of the PRACH transmission occasion described below can be performed in an L-cell (cell operating in the licensed band (L-band)) and/or a U-cell (cell operating in the unlicensed band (U-band)) defined in the NR system or the U-Band system.

NR supports multiple numerologies (or subcarrier spacing (SCS)) for supporting diverse 5G services. For example, if the SCS is 15 kHz, the NR supports a wide area in conventional cellular bands; if the SCS is 30 kHz/60 kHz, the NR supports a dense-urban, lower latency and wider carrier bandwidth; and if the SCS is 60 kHz or higher, the NR supports a bandwidth greater than 24.25 GHz to overcome phase noise.

An NR frequency band is defined as two types of frequency ranges FR1 and FR2. FR1 and FR2 may be configured as shown in Table 5 below. FR2 may mean millimeter wave (mmW).

TABLE 5

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Hereinafter, when a PRACH repetition scheme is introduced for coverage enhancement in NR, a RACH resource partitioning method for PRACH repetition and a related UE/base station operation are proposed. In the present disclosure, ‘PRACH transmission’, ‘RACH transmission’ or ‘preamble transmission’ may be interpreted/replaced as ‘MSG1 transmission’.

Various RAN1 work items are defined to distinguish UE/base station operations based on a RACH resource (e.g., PRACH preamble index, etc.). As an example, UEs related to redcap, small data transmission, Msg. 3 PUSCH repetition, etc., are defined to select a specific preamble index to request from the base station whether to use a corresponding feature in a PRACH preamble transmission step. However, when each operation separately created for each work item are defined, an implementation complexity of the UE/base station may be increased.

Therefore, a concept of “Feature Combination” has been introduced to efficiently support UE/base station operations that need to be distinguished by using the RACH resource (e.g., PRACH preamble index, etc.) in a RAN2 Rel-17 RACH partitioning work item. That is, the base station configures/indicates to the UE that a specific feature or a combination of specific features is supported by configuring a specific PRACH resource (e.g., preamble start index and total number indication). The UE that intends to use/request a specific feature and/or a combination of specific features may select one of preamble indices of a region allocated to the specific feature and/or the combination of the specific features desired by itself during the RACH procedure to transmit a PRACH preamble. RRC parameters for this operation may be “FeatureCombinationPreambles” and “FeatureCombination”. Table 6 below shows the “FeatureCombinationPreambles” and “FeatureCombination”.

TABLE 6

| | |
|---|---|
| FeatureCombinationPreambles-r17 ::= | SEQUENCE |
| featureCombination-r17 | FeatureCombination-r17, |
| startPreambleForThisPartition-r17 | INTEGER (1..64), |

numberOfPreamblesPerSSB-ForThisPartition-r17 INTEGER (1..64),

| | |
|---|---|
| ssb-SharedRO-MaskIndex-r17 | INTEGER (1..15) |
| OPTIONAL, -- Need S | |
| groupBconfigured-r17 | SEQUENCE |
| ra-SizeGroupA-r17 | ENUMERATED {b56, b144, |
| | b |
| | 2 |
| | 0 |
| | 8 |
| | , |
| | b |
| | 2 |
| | 5 |
| | 6 |
| | , |
| | b |
| | 2 |
| | 8 |
| | 2 |
| | , |
| | b |
| | 4 |
| | 8 |
| | 0 |
| | , |
| | b |
| | 6 |
| | 4 |
| | 0 |
| | , |
| | b |
| | 8 |
| | 0 |
| | 0 |
| | , |
| | b |
| | 1 |
| | 0 |
| | 0 |
| | 0 |
| | , |
| | b |
| | 7 |
| | 2 |
| | , |
| | s |
| | p |
| | a |
| | r |
| | e |
| | 6 |
| | , |
| | s |
| | p |
| | a |
| | r |
| | e |
| | 5 |
| | , |
| | s |
| | p |
| | a |
| | r |
| | e |
| | 4 |
| | , |
| | s |
| | p |
| | a |
| | r |
| | e |
| | 3 |
| | , |
| | s |
| | p |
| | a |
| | r |
| | e |
| | 2 |
| | , |
| | s |
| | p |
| | a |
| | r |
| | e |
| | 1 |
| | } |
| | , |
| messagePowerOffsetGroupB | ENUMERATED { |
| | m |
| | in |
| | us |
| | in |
| | fi |
| | ni |
| | ty |
| | , |
| | d |
| | B |
| | 0, |
| | d |
| | B |
| | 5, |
| | d |
| | B |
| | 8, |
| | d |
| | B |
| | 10 |
| | , |
| | d |
| | B |
| | 12 |
| | , |
| | d |
| | B |
| | 15 |
| | , |
| | d |
| | B |
| | 18 |
| | }, |
| numberOfRA-PreamblesGroupA | INTEGER (1..64) |
| } | |
| OPTIONAL, -- Need S | |
| separateMsgA-PUSCH-Config-r17 | MsgA-PUSCH-Config-r16 |

```
  msgA-RSRP-Threshold-r17  RSRP-Range
OPTIONAL, -- Need R
  rsrp-ThresholdSSB-r17  RSRP-Range
OPTIONAL, -- Need R
  deltaPreamble-r17  INTEGER (−1..6)
```

OPTIONAL, -- Need R
...
}

```
FeatureCombination-r17 ::= SEQUENCE {
  redCap-r17  ENUMERATED {true}
OPTIONAL, -- Need R
  smallData-r17 ENUMERATED {true}
OPTIONAL, -- Need R
  nsag-r17  NSAG-List-r17
OPTIONAL, -- Need R
  msg3-Repetitions-r17  ENUMERATED {true}
OPTIONAL, -- Need R
  spare4  ENUMERATED {true}
OPTIONAL, -- Need R
  spare3  ENUMERATED {true}
OPTIONAL, -- Need R
  spare2  ENUMERATED {true}
OPTIONAL, -- Need R
  spare1  ENUMERATED {true}
OPTIONAL -- Need R
```

}

A plurality of FeatureCombinationPreambles parameters may be configured within RACH-ConfigCommon. Preamble index intervals corresponding to each region (i.e., a region/partition based on a preamble(s) belonging to each of the plurality of FeatureCompanyPreamble parameters) need to be configured not to overlap. In addition, features and/or combinations of features configured in respective regions also need to be configured to not overlap with each other. As described above, the parameter(s) for the random access procedure may be initialized/determined based on the RACH resource(s) (e.g., preamble(s)) selected by the UE.

In the present disclosure, a ‘RACH resource’ (or ‘PRACH resource’) may be interpreted/replaced as a random access resource. For example, a FeatureCombination (e.g., a feature or a combination of features) related to RACH resources may be interpreted/replaced as FeatureCombination related to a set of random access resources.

In addition to the RACH-ConfigCommon allocated to existing BWP-UplinkCommon, the base station may additionally allocate a RACH configuration through AdditionalRACH-Config-r17. The BWP-UplinkCommon may be configured based on an SIB (e.g., SIB1). The RACH procedure may be performed as follows by a Rel-16 UE/Rel-17 UE.

For Rel-16 UEs that may not read AdditionalRACH-Config-r17, the UEs perform the RACH procedure based on RACH-ConfigCommon allocated to BWP-UplinkCommon.

For UEs of Rel-17 and later that may read AdditionalRACH-Config-r17, the UEs perform the RACH procedure by confirming RACH-ConfigCommon allocated to the existing BWP-UplinkCommon and RACH-ConfigCommon allocated to the AdditionalRACH-Config-r17.

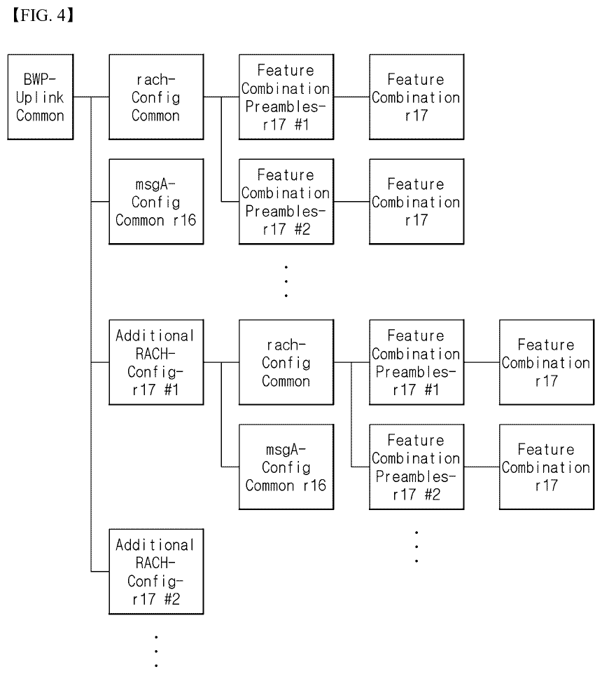

In addition, one or more FeatureCombinationPreambles described above may be configured in the RACH-ConfigCommon allocated to the existing BWP-UplinkCommon. One or more FeatureCombinationPreambles described above may be also configured in the RACH-ConfigCommon allocated to the AdditionalRACH-Config-r17. Hereinafter, this will be described with reference to FIG. 4.

FIG. 4 illustrates an RACH partitioning related RRC parameter. Specifically, FIG. 4 illustrates a connection relationship/up-and-down relationship of the RACH partitioning related RRC parameters.

Respective parameters will be specifically described with reference to FIG. 4. For convenience of description, an RRC parameter (e.g., BWP-UplinkCommon parameter) is described as a parameter name (e.g., BWP-UplinkCommon).

The BWP-UplinkCommon includes i) rach-ConfigCommon, ii) msgA-ConfigCommon, and iii) one or more AdditionalRACH-Config #1, #2, . . . .

Each AdditionalRACH-Config includes i) rach-ConfigCommon and ii) msgA-ConfigCommo.

Each rach-ConfigCommon includes one or more FeatureConbinationPreambles.

Each FeatureConbinationPreambles includes FeatureCombination.

Table 7 shows the RRC parameters described above.

TABLE 7
- BWP-UplinkCommon
The IE BWP-UplinkCommon is used to configure the common parameters of an
uplink BWP. They are “cell specific” and the network ensures the necessary
alignment with corresponding parameters of other UEs. The common parameters
of the initial bandwidth part of the PCell are also provided via system information.
For all other serving cells, the network provides the common parameters via
dedicated signalling.

| | |
|---|---|
| BWP-UplinkCommon ::= | SEQUENCE { |
| genericParameters | BWP, |
| rach-ConfigCommon | SetupRelease { RACH- |
| ConfigCommon } | OPTIONAL, -- |
| Need M | |
| pusch-ConfigCommon | SetupRelease { PUSCH- |
| ConfigCommon } | OPTIONAL, -- |
| Need M | |
| pucch-ConfigCommon | SetupRelease { PUCCH- |
| ConfigCommon } | OPTIONAL, -- |
| Need M | |
| ..., | |
| [[ | |
| rach-ConfigCommonIAB-r16 | SetupRelease { RACH- |
| ConfigCommon } | OPTIONAL, -- |
| Need M | |
| useInterlacePUCCH-PUSCH-r16 | ENUMERATED {enabled} |
| OPTIONAL, -- Need R | |
| msgA-ConfigCommon-r16 | SetupRelease { MsgA- |
| ConfigCommon-r16 } | OPTIONAL -- |
| Cond SpCellOnly2 | |
| ]], | |
| [[ | |
| enableRA-Prioritization ForSlicing-r17 BOOLEAN | |
| OPTIONAL, -- Cond RA-PrioSliceAI | |
| additionalRACH-ConfigList-r17 | SetupRelease { AdditionalRACH- |

ConfigList-r17 } OPTIONAL, -- Cond SpCellOnly2

| | |
|---|---|
| rsrp-ThresholdMsg3-r17 | RSRP-Range |
| OPTIONAL, -- Need R | |
| numberOfMsg3-RepetitionsList-r17 | SEQUENCE (SIZE (4)) OF |
| NumberOfMsg3-Repetitions-r17 | OPTIONAL, -- Cond |
| Msg3Rep | |
| mcs-Msg3-Repetitions-r17 | SEQUENCE (SIZE (8)) OF |
| INTEGER (0..31) | OPTIONAL -- Cond |
| Msg3Rep | |
| ]], | |
| [[ | |

```
  additionalRACH-perPCI-ToAddModList-r18 SEQUENCE (SIZE (1..
maxNrofAdditionalPRACHConfigs-r18)) OF RACH-ConfigTwoTA-r18
OPTIONAL, -- Cond 2TA-Only
  additionalRACH-perPCI-ToReleaseList-r18 SEQUENCE (SIZE (1..
maxNrofAdditionalPRACHConfigs-r18)) OF RACH-ConfigTwoTAIndex-
r18
```

| | |
|---|---|
| OPTIONAL, -- Need N | |
| rsrp-ThresholdMsg1-RepetitionNum2-r18 | RSRP-Range |
| OPTIONAL, -- Cond Msg1Rep1 | |
| rsrp-ThresholdMsg1-RepetitionNum4-r18 | RSRP-Range |
| OPTIONAL, -- Cond Msg1Rep1 | |
| rsrp-ThresholdMsg1-RepetitionNum8-r18 | RSRP-Range |
| OPTIONAL, -- Cond Msg1Rep1 | |
| preambleTransMax-Msg1-Repetition-r18 | ENUMERATED {n1, n2, |
| n4, n6, n8, n10, n20, n50, n100, n200} | OPTIONAL --Cond |
| Msg1Rep1 | |
| ]] | |
| } | |
| AdditionalRACH-ConfigList-r17 ::= | SEQUENCE |

(SIZE(1..maxAdditionalRACH-r17)) OF AdditionalRACH-Config-r17

| | |
|---|---|
| AdditionalRACH-Config-r17 ::= | SEQUENCE { |
| rach-ConfigCommon-r17 | RACH-ConfigCommon |
| OPTIONAL, -- Need R | |
| msgA-ConfigCommon-r17 | MsgA-ConfigCommon-r16 |
| OPTIONAL, -- Need R | |
| ... | |
| } | |
| NumberOfMsg3-Repetitions-r17 ::= | ENUMERATED {n1, n2, n3, n4, |
| n7, n8, n12, n16} | |

BWP-UplinkCommon field descriptions
additionalRACH-ConfigList
List of feature or feature combination-specific RACH configurations, i.e. the
RACH configurations configured in addition to the one configured by rach-
ConfigCommon and by msgA-ConfigCommon. The network associates all
possible preambles of an additional RACH configuration to one or more
feature(s) or feature combination(s). The network does not configure this list to
have more than 32 entries. If both rach-ConfigCommon and msgA-
ConfigCommon are configured for a specific FeatureCombination, the network
always provides them in the same additionalRACH-Config.
additionalRACH-perPCI-ToAddModList
List of RACH configurations for the additional PCIs. The RACH configuration
for an additional PCI is applied for Random Access procedure initiated by
PDCCH order towards to the additional PCI, as specified in TS 38.321 clause
5.1.1b. This configuration may be different for different UEs.
enableRA-PrioritizationForSlicing
Indicates whether or not the ra-PrioritizationForSlicing/ra-
PrioritizationForSlicingTwoStep should override the ra-
PrioritizationForAccessIdentity. The field is applicable only when the UE is
configured by upper layers with both NSAG and Access Identity 1 or 2. If
value TRUE is configured, the UE should only apply the ra-
PrioritizationForSlicing/ra-PrioritizationForSlicingTwoStep. If value FALSE
is configured, the UE should only apply ra-PrioritizationFor AccessIdentity. If
the field is absent, whether to use ra-PrioritizationForSlicing/ra-
PrioritizationForSlicingTwoStep or ra-PrioritizationFor AccessIdentity is up to
UE implementation.
mcs-Msg3-Repetitions
Configuration of eight candidate MCS indexes for PUSCH transmission
scheduled by RAR UL grant and DCI format 0_0 with CRC scrambled by TC-
RNTI. Only the first 4 configured or default MCS indexes are used for PUSCH
transmission scheduled by RAR UL grant. This field is only applicable when
the UE selects Random Access resources indicating Msg3 repetition in this
BWP. If this field is absent when the set(s) of Random Access resources with
MSG3 repetition indication are configured in the BWP-UplinkCommon, the UE
shall apply the values {0, 1, 2, 3, 4, 5, 6, 7} (see TS 38.214 [19], clause 6.1.4).
msgA-ConfigCommon
Configuration of the cell specific PRACH and PUSCH resource parameters for
transmission of MsgA in 2-step random access type procedure. The NW can
configure msgA-ConfigCommon only for UL BWPs if the linked DL BWPs
(same bwp-Id as UL-BWP) are the initial DL BWPs or DL BWPs containing
the SSB associated to the initial DL BWP or DL BWPs associated with
nonCellDefiningSSB or, for (e)RedCap UEs, the (e)RedCap-specific initial
downlink BWP.
numberOfMsg3-RepetitionsList
The number of repetitions for PUSCH transmission scheduled by RAR UL
grant and DCI format 0_0 with CRC scrambled by TC-RNTI. This field is only
applicable when the UE selects Random Access resources indicating Msg3
repetition in this BWP. If this field is absent when the set(s) of Random Access
resources with MSG3 repetition indication are configured in the BWP-
UplinkCommon, the UE shall apply the values {n1, n2, n3, n4} (see TS 38.214
[19], clause 6.1.2.1).
preambleTransMax-Msg1-Repetition
Max number of transmissions of MSG1 repetitions number (2, 4 and 8)
performed before switching to higher repetition number (see TS 38.321 [3],
clauses 5.1.1). This field is only applicable when more than one repetition
numbers are configured in shared RO. If the field is absent, switching from
lower repetition number to higher repetition number is not allowed.
pucch-ConfigCommon
Cell specific parameters for the PUCCH of this BWP.
pusch-ConfigCommon
Cell specific parameters for the PUSCH of this BWP.
rach-ConfigCommon
Configuration of cell specific random access parameters which the UE uses for
contention based and contention free random access as well as for contention
based beam failure recovery in this BWP. The NW configures SSB-based RA
(and hence RACH-ConfigCommon) only for UL BWPs if the linked DL BWPs
(same bwp-Id as UL-BWP) are the initial DL BWPs or DL BWPs containing
the SSB associated to the initial DL BWP or DL BWPs associated with
nonCellDefiningSSB or, for (e)RedCap UEs, the (e)RedCap-specific initial
downlink BWP. The network configures rach-ConfigCommon, whenever it
configures contention free random access (for reconfiguration with sync or for
beam failure recovery). For (e)RedCap-specific initial uplink BWP, rach-
ConfigCommon is always configured when msgA-ConfigCommon is
configured in this BWP.
rach-ConfigCommonIAB
Configuration of cell specific random access parameters for the IAB-MT. The
IAB specific IAB RACH configuration is used by IAB-MT, if configured.
rsrp-ThresholdMsg1-RepetitionNum2, rsrp-ThresholdMsg1-RepetitionNum4,
rsrp-ThresholdMsg1-RepetitionNum8
Threshold used by the UE for determining whether to select resources indicating
Msg1 repetition number 2, 4 or 8 in this BWP, as specified in TS 38.321 [3].
The value applies to all the BWPs and all RACH configurations. This field is
mandatory if both set(s) of Random Access resources with MSG1 repetition
indication and set(s) of Random Access resources without MSG1 repetition
indication are configured in the BWP, or if all set(s) of Random Access
resources are configured with MSG1 repetition indication but associated with
different repetition numbers in the BWP. It is absent otherwise.
rsrp-ThresholdMsg3
Threshold used by the UE for determining whether to select resources indicating
Msg3 repetition in this BWP, as specified in TS 38.321 [3]. The field is
mandatory if both set(s) of Random Access resources with MSG3 repetition
indication and set(s) of Random Access resources without MSG3 repetition
indication are configured in the BWP. It is absent otherwise.
useInterlacePUCCH-PUSCH
If the field is present, the UE uses uplink frequency domain resource allocation
Type 2 for cell-specific PUSCH, e.g., PUSCH scheduled by RAR UL grant (see
TS 38.213 [13] clause 8.3 and TS 38.214 [19], clause 6.1.2.2) and uses
interlaced PUCCH Format 0 and 1 for cell-specific PUCCH (see TS 38.213
[13], clause 9.2.1).

| Conditional | |
|---|---|
| Presence | Explanation |
| Msg1Rep1 | |
| | Random Access resources with MSG1 repetition |
| | indication are configured in the BWP-UplinkCommon. It |
| | is absent otherwise. |
| Msg3Rep | This field is optionally present, Need S, if the set(s) of |
| | Random Access resources with MSG3 repetition |
| | indication are configured in the BWP-UplinkCommon. It |
| | is absent otherwise. |
| RA-PrioSliceAI | The field is optionally present in SIB1, Need R, if both |
| | parameters ra-PrioritizationForAccessIdentity and the |
| | ra-PrioritizationForSlicing/ra- |
| | PrioritizationForSlicingTwoStep are present in SIB1. It |
| | is absent otherwise. |
| SpCellOnly2 | The field is optionally present, Need M, in the BWP- |
| | UplinkCommon of an SpCell. It is absent otherwise. |
| 2TA-Only | The field is optionally present, Need N in the BWP- |
| | UplinkCommon if additionalPCI-ToAddModList is |
| | present in spCellConfigDedicated or |
| | sCellConfigDedicated and it has the same number of |
| | entries as the additionalPCI-ToAddModList. It is absent |
| | otherwise. |
| - RACH-ConfigCommon | |

The IE RACH-ConfigCommon is used to specify the cell specific random-access
parameters.

| RACH-ConfigCommon ::= | SEQUENCE { |
|---|---|
| rach-ConfigGeneric | RACH-ConfigGeneric, |
| totalNumberOfRA-Preambles | INTEGER (1..63) |
| OPTIONAL, -- Need S | |

ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED |
| {n4,n8,n12,n16,n20,n24,n28,n32}, | |
| four | INTEGER (1..16), |
| eight | INTEGER (1..8), |
| sixteen | INTEGER (1..4) |
| } | |
| OPTIONAL, -- Need M | |
| groupBconfigured | SEQUENCE { |
| ra-Msg3SizeGroupA | ENUMERATED {b56, b144, |
| b208, b256, b282, b480, b640, | |
| | b800, b1000, b72, |
| spare6, spare5,spare4, spare3, spare2, spare1}, | |
| messagePowerOffsetGroupB | ENUMERATED { |
| minusinfinity, dB0, dB5, dB8, dB10, dB12, dB15, dB18}, | |
| numberOfRA-PreamblesGroupA | INTEGER (1..64) |
| } | |
| OPTIONAL, -- Need R | |
| ra-ContentionResolutionTimer | ENUMERATED { sf8, sf16, |
| sf24, sf32, sf40, sf48, sf56, sf64}, | |
| rsrp-ThresholdSSB | RSRP-Range |
| OPTIONAL, -- Need R | |
| rsrp-ThresholdSSB-SUL | RSRP-Range |
| OPTIONAL, -- Cond SUL | |
| prach-RootSequenceIndex | CHOICE { |
| l839 | INTEGER (0..837), |
| l139 | INTEGER (0..137) |
| }, | |
| msg1-SubcarrierSpacing | SubcarrierSpacing |
| OPTIONAL, -- Cond L139 | |
| restrictedSetConfig | ENUMERATED |
| {unrestrictedSet, restrictedSetTypeA, restrictedSetTypeB}, | |
| msg3-transformPrecoder | ENUMERATED {enabled} |
| OPTIONAL, -- Need R | |
| ..., | |
| [[ | |
| ra-PrioritizationForAccessIdentity-r16 | SEQUENCE { |
| ra-Prioritization-r16 | RA-Prioritization, |
| ra-PrioritizationForAI-r16 | BIT STRING (SIZE (2)) |
| } | |
| OPTIONAL -- Cond InitialBWP-Only | |
| prach-RootSequenceIndex-r16 | CHOICE { |
| l571 | INTEGER (0..569), |
| l1151 | INTEGER (0..1149), |
| } OPTIONAL -- Need R | |
| ]], | |
| [[ | |
| ra-PrioritizationForSlicing-r17 | RA-PrioritizationForSlicing-r17 |
| OPTIONAL, -- Cond InitialBWP-Only | |
| featureCombinationPreamblesList-r17 | SEQUENCE |

(SIZE(1..maxFeatureCombPreamblesPerRACHResource-r17)) OF
FeatureCombinationPreambles-r17 OPTIONAL -- Cond AdditionalRACH

]]
}
-- TAG-RACH-CONFIGCOMMON-STOP

featureCombinationPreamblesList
Specifies a series of preamble partitions each associated to a combination of
features and 4-step RA. The network does not configure this list to have more
than 32 entries.
messagePowerOffsetGroupB
Threshold for preamble selection. Value is in dB. Value minusinfinity
corresponds to -infinity. Value dB0 corresponds to 0 dB, dB5 corresponds to 5
dB and so on (see TS 38.321 [3], clause 5.1.2). This field is set to the same value
for different repetition numbers associated with a specific FeatureCombination.
msg1-SubcarrierSpacing
Subcarrier spacing of PRACH (see TS 38.211 [16], clause 5.3.2).
Only the following values are applicable depending on the used frequency:
FR1: 15 or 30 kHz
FR2-1: 60 or 120 kHz
FR2-2: 120, 480, or 960 kHz
If absent, the UE applies the SCS as derived from the prach-ConfigurationIndex
in RACH-ConfigGeneric (see tables Table 6.3.3.1-1, Table 6.3.3.1-2, Table
6.3.3.2-2 and Table 6.3.3.2-3, TS 38.211 [16]). The value also applies to
contention free random access (RACH-ConfigDedicated), to SI-request and to
contention-based beam failure recovery (CB-BFR). But it does not apply for
contention free beam failure recovery (CF-BFR) (see
BeamFailureRecoveryConfig).
msg3-transformPrecoder
Enables the transform precoder for Msg3 transmission according to clause
6.1.3 of TS 38.214 [19]. If the field is absent, the UE disables the transformer
precoder (see TS 38.213 [13], clause 8.3).
numberOfRA-PreamblesGroupA
The number of CB preambles per SSB in group A. This determines implicitly
the number of CB preambles per SSB available in group B. (see TS 38.321
[3], clause 5.1.1). The setting should be consistent with the setting of ssb-
perRACH-OccasionAndCB-PreamblesPerSSB.
prach-RootSequenceIndex
PRACH root sequence index (see TS 38.211 [16], clause 6.3.3.1). The value
range depends on whether L = 839 or L = 139 or L = 571 or L = 1151. The length
of the root sequence corresponding with the index indicated in this IE should
be consistent with the one indicated in prach-ConfigurationIndex in the
RACH-ConfigDedicated (if configured). If prach-RootSequenceIndex-r16 is
signalled, UE shall ignore the prach-RootSequenceIndex (without suffix).
For FR2-2, only the following values are applicable depending on the used
subcarrier spacing:
120 kHz: L = 139, L = 571, and L = 1151
480 kHz: L = 139, and L = 571
960 kHz: L = 139
ra-ContentionResolution Timer
The initial value for the contention resolution timer (see TS 38.321 [3], clause
5.1.5). Value sf8 corresponds to 8 subframes, value sf16 corresponds to 16
subframes, and so on.
ra-Msg3SizeGroupA
Transport Blocks size threshold in bits below which the UE shall use a
contention-based RA preamble of group A (see TS 38.321 [3], clause 5.1.2).
This field is set to the same value for different repetition numbers associated
with a specific FeatureCombination.
ra-Prioritization
Parameters which apply for prioritized random access procedure on any UL
BWP of SpCell for specific Access Identities (see TS 38.321 [3], clause
5.1.1a).
ra-Prioritization ForAI
Indicates whether the field ra-Prioritization-r16 applies for Access Identities.
The first/leftmost bit corresponds to Access Identity 1, the next bit
corresponds to Access Identity 2. Value 1 indicates that the field ra-
Prioritization-r16 applies otherwise the field does not apply (see TS 23.501
[32]).
ra-Prioritization ForSlicing
Parameters which apply to configure prioritized CBRA 4-step random access
type for slicing.
rach-ConfigGeneric
RACH parameters for both regular random access and beam failure recovery.
restrictedSetConfig
Configuration of an unrestricted set or one of two types of restricted sets, see
TS 38.211 [16], clause 6.3.3.1.
rsrp-ThresholdSSB
UE may select the SS block and corresponding PRACH resource for path-loss
estimation and (re)transmission based on SS blocks that satisfy the threshold
(see TS 38.213 [13]).
rsrp-ThresholdSSB-SUL
The UE selects SUL carrier to perform random access based on this threshold
(see TS 38.321 [3], clause 5.1.1). The value applies to all the BWPs and all
RACH configurations.
ssb-perRACH-OccasionAndCB-PreamblesPerSSB
The meaning of this field is twofold: the CHOICE conveys the information
about the number of SSBs per RACH occasion. Value oneEighth corresponds
to one SSB associated with 8 RACH occasions, value oneFourth corresponds
to one SSB associated with 4 RACH occasions, and so on. The
ENUMERATED part indicates the number of Contention Based preambles
per SSB. Value n4 corresponds to 4 Contention Based preambles per SSB,
value n8 corresponds to 8 Contention Based preambles per SSB, and so on.
The total number of CB preambles in a RACH occasion is given by CB-
preambles-per-SSB * max(1, SSB-per-rach-occasion). See TS 38.213 [13].
totalNumberOfRA-Preambles
Total number of preambles used for contention based and contention free 4-
step or 2-step random access in the RACH resources defined in RACH-
ConfigCommon, excluding preambles used for other purposes (e.g. for SI
request). If the field is absent, all 64 preambles are available for RA. The
setting should be consistent with the setting of ssb-perRACH-
OccasionAndCB-PreamblesPerSSB, i.e. it should be a multiple of the number
of SSBs per RACH occasion.

| Conditional | |
|---|---|
| Presence | Explanation |
| AdditionalRACH | The field is mandatory present if the RACH- |
| | ConfigCommon is included in an AdditionalRACH- |
| | Config. When included in initialUplinkBWP-RedCap to |
| | indicate other feature(s) than redcap and eRedCap, this |
| | field is mandatory present with at least |
| | FeatureCombinationPreambles list entries: the list |
| | entry/entries indicating only redcap or eRedCap and |
| | the other(s) indicating both redcap or eRedCap and one |
| | or multiple other feature(s) (e.g., smallData, nsag or |
| | msg3-Repetitions). |
| | Otherwise, it is optional, Need R. |
| InitialBWP-Only | This field is optionally present, Need R, if this BWP is |
| | the initial BWP of SpCell. Otherwise, the field is |
| | absent. |
| L139 | The field is mandatory present if prach- |
| | RootSequenceIndex L = 139, otherwise the field is |
| | absent, Need S. |
| SUL | The field is mandatory present in rach-ConfigCommon |
| | in initialUplinkBWP if supplementaryUplink is |
| | configured in ServingCellConfigCommonSIB or if |
| | supplementaryUplinkConfig is configured in |
| | ServingCellConfigCommon; otherwise, the field is |
| | absent. This field is not configured in additionalRACH- |
| | Config. |

The introduction of PRACH preamble repetition transmissions is being considered to enhance UL coverage in the existing NR system.

When multiple PRACH resources with different repetition transmission numbers are allocated and overlapping (or collision) between the PRACH resources occurs, UE/base station operations for solving this are described below.

In the present disclosure, ‘RO’ denotes a RACH occasion (or PRACH occasion).

### Method of Handling Overlapping/Collision Between RACH Resources

Multiple methods of allocating PRACH repetition resources with different repetition transmission numbers are being considered. In this instance, when considering a method of allocating RACH resources so that multiple PRACH repetition resources with different repetition transmission numbers are distinguished based on an RO level, ROs corresponding to different RACH configurations may overlap each other on a time domain and/or a frequency domain. Therefore, for this case, it is necessary to define the UE/base station operations. In the present disclosure, the ‘overlapping of ROs’ may be interpreted/replaced as the ‘collision of ROs’.

Based on the overlapping/collision of ROs configured to the UE by the base station, the UE may configure/determine all or part of the ROs as invalid ROs. The ROs may be ROs based on different configurations (e.g., different repetition numbers).

Specifically, when ROs corresponding to a RACH configuration assigned to a specific repetition number overlap all or part of ROs corresponding to RACH configurations assigned to different repetition numbers on the time domain and/or the frequency domain, all or part of the overlapping ROs may be configured/determined as invalid ROs.

Hereinafter, the configuration/determination of the invalid RO may mean configuration/determination by the UE and/or the base station. For example, if the UE and/or the base station configures/determines a specific RO as an invalid RO, the UE does not use the specific RO, and the base station does not expect to receive a PRACH based on the specific RO.

A method of configuring/determining the invalid RO(s) is described in detail below.

### Method 1

A method may be considered to process only ROs corresponding to a specific RACH configuration (and/or a specific RACH partitioning) among overlapping ROs as invalid ROs. For example, ROs corresponding to a specific RACH configuration (and/or a specific RACH partitioning) may be i) ROs based on a specific RACH configuration (and/or a specific RACH partitioning), ii) ROs related to a specific RACH configuration (and/or a specific RACH partitioning), or iii) ROs configured based on a specific RACH configuration (and/or a specific RACH partitioning). For example, referring to FIG. 4 and Table 7, the RACH configuration may mean rach-ConfigCommon, and the RACH partitioning may mean FeatureCombinationPreambles.

Among multiple RACH configurations (and/or specific RACH partitionings) configured by the base station, a specific RACH configuration (and/or specific RACH partitioning) for determining the invalid RO may be defined based on at least one of the following examples.

For example, the specific RACH configuration (and/or specific RACH partitioning) may be a RACH configuration (and/or RACH partitioning) with a relatively large repetition number among the multiple RACH configurations (and/or specific RACH partitionings). As a specific example, an RO related to a RACH configuration (and/or RACH partitioning) with a largest repetition number may be determined/processed as the invalid RO.

For example, the specific RACH configuration (and/or specific RACH partitioning) may be a RACH configuration (and/or RACH partitioning) with a relatively small repetition number among the multiple RACH configurations (and/or specific RACH partitionings). As a specific example, an RO related to a RACH configuration (and/or RACH partitioning) with a smallest repetition number may be determined/processed as the invalid RO.

For example, the specific RACH configuration (and/or specific RACH partitioning) may be RACH configuration (and/or RACH partitioning) may be a RACH configuration (and/or RACH partitioning) with a lowest (or highest) priority value configured by the base station among the multiple RACH configurations (and/or specific RACH partitioning). As a specific example, an RO related to the RACH configuration (and/or RACH partitioning) with the lowest (or highest) priority value may be determined/processed as the invalid RO.

The base station may configure a priority to the UE as follows. The priority may be independently configured/indicated per RACH configuration (and/or specific RACH partitioning) via higher layer parameter.

For example, based on overlapping ROs having the same repetition number, the invalid RO may be determined based on the priority related to each RO. For example, based on the priorities of the overlapping ROs being the same, the invalid RO may be determined based on a priority number related to each RO.

For example, it may be assumed that ROs corresponding to a single PRACH resource and ROs corresponding to multiple PRACH resources with a repetition number of 2 overlap entirely or partially on the time domain and/or the frequency domain. The UE and the base station may be configured to interpret/determine the ROs corresponding to the multiple PRACH resources with the repetition number of 2 as invalid ROs.

For example, it may be assumed that the ROs corresponding to the multiple PRACH resources with the repetition number of 2 and ROs corresponding to multiple PRACH resources with a repetition number of 4 overlap entirely or partially on the time domain and/or the frequency domain. The UE and the base station may be configured to interpret/determine the ROs corresponding to the multiple PRACH resources with the repetition number of 4 as invalid ROs.

The UE may perform a RACH procedure based on the ROs configured/determined as the invalid ROs and FDMed (Frequency Division Multiplexed) ROs. Specifically, if there are FDMed RO(s) that do not overlap with other ROs in the same time instance (same time resource index) as the invalid RO, the UE may additionally select the FDMed ROs (or one of the FDMed ROs). The UE may reselect the FDMed RO into a RO group and perform the RACH procedure.

If there is no FDMed RO that does not overlap with other ROs in the same time instance as the RO configured/determined as the invalid RO, the UE may additionally select an RO of a next time instance. The UE may reselect the RO of the next time instance into a RO group and perform the RACH procedure.

### Method 2

A method of configuring/determining all overlapping ROs as invalid ROs may be considered. That is, a UE may expect that a base station pre-configures RACH resources so that ROs do not overlap entirely or partially on a time domain and/or a frequency domain. If ROs based on different RACH configurations overlap wholly or partially on the time domain and/or the frequency domain, the UE and the base station may configure/determine/process all the overlapping ROs as invalid ROs.

In this instance, the UE may expect that specific PRACH configuration indexes that may overlap with any RACH configuration (e.g., legacy RACH configuration) configured by the base station on the time domain and/or the frequency domain will not be used for other RACH configurations. In other words, the UE may expect that different RACH configurations configured/indicated by the base station do not overlap with each other on the time domain and/or the frequency domain. Specifically, the UE may expect that a PRACH configuration index and/or the number of FDMed ROs related to each RACH configuration will be configured so that different RACH configurations do not overlap with each other on the time domain and/or the frequency domain.

The above-described method 1/method 2 assume a single cell environment as a main target, but are not limited thereto. That is, the method 1/method 2 may be similarly applied in a dual connectivity (DC) environment. That is, even if multiple PRACH configurations with different repetition numbers are configured/indicated to a primary cell (PCell), one or multiple PRACH configurations with different repetition numbers may be additionally configured/indicated to a primary secondary cell (PSCell). As a result, although the PRACH configurations configured/indicated to the PCell and the PRACH configurations of the PSCell are FDMed via carriers, they may overlap on the time domain. In other words, ROs based on different PRACH configurations may overlap even in the DC environment.

In another aspect, the PRACH configurations of the PCell may collide with PUSCH/PUCCH/SRS, etc. of the PSCell. Or, PUSCH/PUCCH/SRS, etc. of the PCell may collide with the PRACH configurations of the PSCell.

In the above situation, if one or more ROs (or PUSCH/PUCCH/SRS) of the PCell overlap with one or more ROs (or PUSCH/PUCCH/SRS) of the PSCell on the time domain and/or the frequency domain, the UE and the base station may configure the RO (or PUSCH/PUCCH/SRS) of the PCell to be valid and may configure/determine the RO (or PUSCH/PUCCH/SRS) of the PSCell to be invalid. That is, the UE may not use the invalid RO and may drop the PUSCH/PUCCH/SRS determined to be invalid.

Alternatively, if the ROs of PScell overlap on the time domain and/or the frequency domain, the UE and the base station may determine the valid/invalid ROs using one of the above-mentioned methods (e.g., repetition number, priority, etc.).

The proposed methods can be configured/applied to other UL signals/channels such as MSG3 PUSCH, MSGA Preamble/PUSCH and/or PUSCH/PUCCH. Characteristically, the proposed UE/base station operations for PRACH repetition can also be configured/applied as UE/base station operations for other newly introduced features (e.g., repetition transmission features of Msg. 4 HARQ ACK PUCCH). For example, the feature for PUCCH repetition (e.g., pucch-Repetitions-r18) can be configured/applied instead of the feature for the proposed PRACH repetition, and the feature for PUCCH repetition can also be used for the proposed combination method and a method that the UE does not expect. Furthermore, when UE/base station operations for PRACH repetition and/or PUCCH repetition are supported simultaneously, the proposed methods can be configured/applied to all the two channels.

Since examples of the proposed methods described above can also be included as one of the implementation methods of the present disclosure, it is obvious that they can be considered as a kind of proposed methods. In addition, the proposed methods described above can be implemented independently, but can also be implemented in the form of a combination (or merge) of some proposed methods. Information on whether the proposed methods are applied (or information on rules of the proposed methods) may be defined as a rule so that the base station informs the UE via a predefined signal (e.g., a physical layer signal or a higher layer signal). For example, the higher layer may include one or more of functional layers such as MAC, RLC, PDCP, RRC, and SDAP.

Methods, embodiments, or descriptions for implementing the methods proposed in the present disclosure can be applied separately, or one or more methods (or embodiments or descriptions) can be applied in combination.

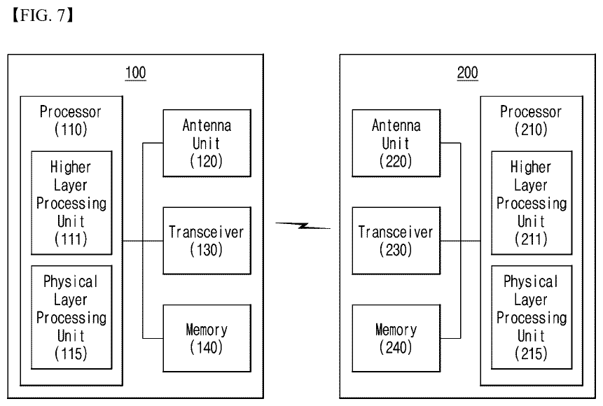

From an implementation perspective, operations of a base station/UE according to the above-described embodiments (e.g., operations based on at least one of the methods 1 and 2) can be processed by a device (e.g., processors 110 and 210 of FIG. 7) of FIG. 7 described below.

Further, the operations of the base station/UE according to the above-described embodiments (e.g., operations based on at least one of the methods 1 and 2) can be stored in a memory (e.g., memories 140 and 240 of FIG. 7) in the form of commands/programs (e.g., instructions, executable codes) for running at least one processor (e.g., processors 110 and 210 of FIG. 7).

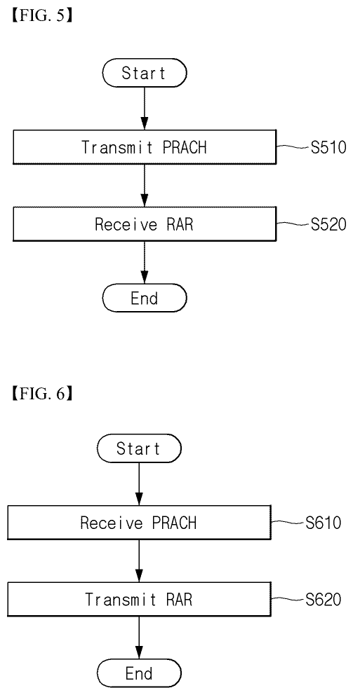

Below, the above-described embodiments are described in detail from a UE and base station operation perspective with reference to FIGS. 5 and 6. Methods described below are merely distinguished for convenience of explanation. Thus, it is obvious that partial configuration of any method can be substituted or combined with partial configuration of another method.

FIG. 5 is a flowchart illustrating a method performed by a user equipment (UE) according to an embodiment of the present disclosure.

Referring to FIG. 5, a method performed by a user equipment (UE) according to an embodiment of the present disclosure includes a PRACH transmission step S510 and a RAR reception step S520.

In the step S510, the UE transmits a Physical Random Access CHannel (PRACH) to a base station.

The PRACH may be transmitted based on at least one PRACH occasion. For example, the number of the at least one PRACH occasion may be one. For example, the number of the at least one PRACH occasion may be based on a repetition number. The at least one PRACH occasion may be based on Tables 1 to 4 and FIG. 2.

The at least one PRACH occasion may be determined based on multiple PRACH occasions. The at least one PRACH occasion may be based on a valid PRACH occasion. In this case, an invalid PRACH occasion among the multiple PRACH occasions may be determined based on the following embodiments.

According to an embodiment, among the multiple PRACH occasions, a second PRACH occasion related to a second configuration that overlaps with a first PRACH occasion related to a first configuration may be determined to be invalid. The present embodiment may be based on the method 1 and/or the method 2.

For example, the multiple PRACH occasions may include PRACH occasions based on multiple configurations. The multiple configurations may be based on i) multiple RACH configurations or ii) multiple preamble configurations. The multiple RACH occasions may be based on rach-ConfigCommon of FIG. 4 and Table 7. The multiple preamble configurations (e.g., RACH partitionings) may be based on FeatureCombinationPreambles of FIG. 4 and Table 7.

For example, the second configuration may be a configuration determined based on at least one of i) a repetition number, ii) a priority, and/or iii) a serving cell among configurations related to overlapping PRACH occasions. The present embodiment may be based on the method 1. A method of determining the second configuration (specific RACH configuration and/or specific RACH partitioning) is described in detail below.

Based on the configurations being related to a same repetition number, the second configuration may be determined based on the priority.

Based on the configurations being related to a same priority, the second configuration may be determined based on the repetition number.

The second configuration may be determined based on the repetition number. For example, the repetition number related to the second configuration may be greater than a repetition number related to the first configuration. For example, the repetition number related to the second configuration may be less than the repetition number related to the first configuration.

The second configuration may be determined based on the priority. For example, the priority related to the second configuration may be lower than a priority related to the first configuration. As a specific example, a priority value related to the second configuration may be greater than a priority value related to the first configuration. Here, a lowest priority value (highest priority value) may mean a highest priority (lowest priority).

A configuration related to a primary secondary cell (PSCell) among the configurations may be determined as the second configuration. Specifically, the second configuration may be related to the PSCell. The first configuration may be related to a primary cell (PCell).

According to an embodiment, the at least one PRACH occasion may include a frequency division multiplexed (FDMed) PRACH occasion in the same time resource as the second PRACH occasion. The present embodiment may be based on the method 1. That is, the FDMed PRACH occasion may mean an FDMed RO in the method 1.

According to an embodiment, the first PRACH occasion and the second PRACH occasion may be determined as invalid PRACH occasions. The present embodiment may be based on the method 2. That is, all the overlapping PRACH occasions may be determined to be invalid.

In the step S520, the UE receives a random access response (RAR) from the base station.

The operations based on the steps S510 and S520 described above may be implemented by a device of FIG. 7. For example, a UE 200 may control one or more transceivers 230 and/or one or more memories 240 so as to perform the operations based on the steps S510 and S520.

Below, the above-described embodiments are described in detail from a perspective of base station operation.

Steps S610 and S620 described below correspond to the steps S510 and S520 described with reference to FIG. 5. Considering the above correspondence, redundant description is omitted. That is, the detailed description of the base station operation described below can be replaced with the description/embodiment of FIG. 5 corresponding to the base station operation. For example, the description/embodiment of the steps S510 and S520 of FIG. 5 may be additionally applied to the base station operation of the steps S610 and S620 described below.

FIG. 6 is a flowchart illustrating a method performed by a base station according to another embodiment of the present disclosure.

Referring to FIG. 6, a method performed by a base station according to another embodiment of the present disclosure includes a PRACH reception step S610 and a RAR transmission step S620.

In the step S610, the base station receives a Physical Random Access CHannel (PRACH) from a UE. The PRACH is received based on at least one PRACH occasion.

In the step S620, the base station transmits a random access response (RAR) to the UE.

The operations based on the steps S610 and S620 described above may be implemented by a device of FIG. 7. For example, a base station 100 may control one or more transceivers 130 and/or one or more memories 140 so as to perform the operations based on the steps S610 and S620.

The operations/terms based on the above-described embodiments have been described assuming the 5G system. However, this is merely for convenience of explanation and is not intended to limit the scope of application of the technical problem and the problem solution to be solved by the present disclosure to a specific system. That is, the technical challenges/technical issues/problems mentioned in the present disclosure may equally exist in other systems (e.g., 6G system). It is obvious that embodiments of the present disclosure can be extended and applied to solve the same problems in the other systems. Therefore, for expanded application of embodiments of the present disclosure to other systems, terms defined/described based on the 5G system can be replaced/changed with terms defined in the other systems (or generalized terms not specific to one system).

A device to which an embodiment of the present disclosure is applicable (a device implementing the method/operation according to an embodiment of the present disclosure) is described below with reference to FIG. 7.

FIG. 7 illustrates configuration of a first device and a second device according to an embodiment of the present disclosure.

A first device 100 may include a processor 110, an antenna unit 120, a transceiver 130, and a memory 140.

The processor 110 may perform baseband-related signal processing and include a higher layer processing unit 111 and a physical layer processing unit 115. The higher layer processing unit 111 may process operations of the MAC layer, the RRC layer, or higher layers. The physical layer processing unit 115 may process the operation of the PHY layer. For example, if the first device 100 is a base station (BS) device in BS-UE communication, the physical layer processing unit 115 may perform uplink reception signal processing, downlink transmission signal processing, and the like. For example, if the first device 100 is a first UE device in inter-UE communication, the physical layer processing unit 115 may performs downlink reception signal processing, uplink transmission signal processing, sidelink transmission signal processing, and the like. The processor 110 may control the overall operation of the first device 100 in addition to performing the baseband-related signal processing.

The antenna unit 120 may include one or more physical antennas and support MIMO transmission/reception if the antenna unit 120 includes a plurality of antennas. The transceiver 130 may include a radio frequency (RF) transmitter and an RF receiver. The memory 140 may store information processed by the processor 110 and software, operating systems, and applications related to the operation of the first device 100. The memory 140 may also include components such as a buffer.

The processor 110 of the first device 100 may be configured to implement the operation of the BS in the BS-UE communication (or the operation of the first UE device in the inter-UE communication) in embodiments described in the present disclosure.

The second device 200 may include a processor 210, an antenna unit 220, a transceiver 230, and a memory 240.

The processor 210 may perform baseband-related signal processing and include a higher layer processing unit 211 and a physical layer processing unit 215. The higher layer processing unit 211 may process the operation of the MAC layer, the RRC layer, or higher layers. The physical layer processing unit 215 may process the operation of the PHY layer. For example, if the second device 200 is a UE device in BS-UE communication, the physical layer processing unit 215 may perform downlink reception signal processing, uplink transmission signal processing, and the like. For example, if the second device 200 is a second UE device in inter-UE communication, the physical layer processing unit 215 may perform downlink reception signal processing, uplink transmission signal processing, sidelink reception signal processing, and the like. The processor 210 may control the overall operation of the second device 210 in addition to performing the baseband-related signal processing.

The antenna unit 220 may include one or more physical antennas and support MIMO transmission/reception if the antenna unit 220 includes a plurality of antennas. The transceiver 230 may include an RF transmitter and an RF receiver. The memory 240 may store information processed by the processor 210 and software, operating systems, and applications related to the operation of the second device 200. The memory 240 may also include components such as a buffer.

The processor 210 of the second device 200 may be configured to implement the operation of the UE in the BS-UE communication (or the operation of the second UE device in the inter-UE communication) in embodiments described in the present disclosure.

The descriptions for the BS and the UE in the BS-UE communication (or the first UE device and the second UE device in the inter-UE communication) in the examples of the present disclosure can be equally applied to the operations of the first device 100 and the second device 200, and redundant descriptions are omitted.

The wireless communication technology implemented in the devices 100 and 200 according to the present disclosure may further include narrowband Internet of Things (NB-IoT) for low-power communication in addition to LTE, NR, and 6G. For example, the NB-IoT technology may be an example of a low power wide area network (LPWAN) technology and may be implemented in standards such as LTE Cat NB1 and/or LTE Cat NB2. The NB-IoT technology is not limited to the above-described names.

Additionally or alternatively, the wireless communication technology implemented in the devices 100 and 200 according to the present disclosure may perform communication based on LTE-M technology. For example, the LTE-M technology may be an example of the LPWAN technology, and may be called by various names such as enhanced machine type communication (eMTC). For example, the LTE-M technology may be implemented with at least one of various standards such as 1) LTE CAT 0, 2) LTE Cat M1, 3) LTE Cat M2, 4) LTE non-BL (non-Bandwidth Limited), 5) LTE-MTC, 6) LTE machine type communication, and/or 7) LTE M. The LTE-M technology is not limited to the above-mentioned names.

Additionally or alternatively, the wireless communication technology implemented in the devices 100 and 200 according to the present disclosure may include at least one of ZigBee, Bluetooth, and low power wide area network (LPWAN) in consideration of low power communication, and is not limited to the above-mentioned names. For example, the ZigBee technology may create personal area networks (PAN) related to small/low-power digital communication based on various standards such as IEEE 802.15.4, and may be called by various names.

1. A method comprising:
transmitting, by a user equipment (UE), a Physical Random Access CHannel (PRACH); and
receiving, by the UE, a Random Access Response (RAR),
wherein the PRACH is transmitted based on at least one PRACH occasion,
wherein the at least one PRACH is determined based on a plurality of PRACH occasions,
wherein the at least one PRACH is based on a valid PRACH occasion, and
wherein, among the plurality of PRACH occasions, a second PRACH occasion related to a second configuration that overlaps with a first PRACH occasion related to a first configuration is determined to be invalid.

2. The method of claim 1, wherein the plurality of PRACH occasions include PRACH occasions based on multiple configurations.

3. The method of claim 2, wherein the multiple configurations are based on i) multiple RACH configurations or ii) multiple preamble configurations.

4. The method of claim 2, wherein the second configuration is a configuration determined based on at least one of i) a repetition number, ii) a priority, and/or iii) a serving cell among configurations related to overlapping PRACH occasions.

5. The method of claim 4, wherein based on the configurations being related to a same repetition number, the second configuration is determined based on the priority.

6. The method of claim 4, wherein based on the configurations being related to a same priority, the second configuration is determined based on the repetition number.

7. The method of claim 4, wherein the repetition number related to the second configuration is greater than a repetition number related to the first configuration.

8. The method of claim 4, wherein the priority related to the second configuration is lower than a priority related to the first configuration.

9. The method of claim 4, wherein the second configuration is related to a primary secondary cell (PSCell), and the first configuration is related to a primary cell (PCell).

10. The method of claim 1, wherein the at least one PRACH occasion includes a frequency division multiplexed (FDMed) PRACH occasion in the same time resource as the second PRACH occasion.

11. The method of claim 1, wherein the first PRACH occasion and the second PRACH occasion are determined as invalid PRACH occasions.

12. A user equipment (UE) comprising:
one or more transceivers;
one or more processors; and
one or more memories connected to the one or more processors and storing instructions,
wherein the instructions configure the one or more processors to perform, based on being executed by the one or more processors, operations comprising:
transmitting a Physical Random Access CHannel (PRACH); and
receiving a Random Access Response (RAR),
wherein the PRACH is transmitted based on at least one PRACH occasion,
wherein the at least one PRACH is determined based on a plurality of PRACH occasions,
wherein the at least one PRACH is based on a valid PRACH occasion, and
wherein, among the plurality of PRACH occasions, a second PRACH occasion related to a second configuration that overlaps with a first PRACH occasion related to a first configuration is determined to be invalid.

13. (canceled)

14. (canceled)

15. (canceled)

16. A base station comprising:
one or more transceivers;
one or more processors; and
one or more memories connected to the one or more processors and storing instructions,
wherein the instructions configure the one or more processors to perform, based on being executed by the one or more processors, operations comprising:
receiving a Physical Random Access CHannel (PRACH); and
transmitting a Random Access Response (RAR),
wherein the PRACH is received based on at least one PRACH occasion,
wherein the at least one PRACH is determined based on a plurality of PRACH occasions,
wherein the at least one PRACH is based on a valid PRACH occasion, and
wherein, among the plurality of PRACH occasions, a second PRACH occasion related to a second configuration that overlaps with a first PRACH occasion related to a first configuration is determined to be invalid.
